(19) United States
(12) Patent Application Publication
(10) Pub. No.: US 2021/0093421 A1
(43) Pub. Date: Apr. 1, 2021

(54) DENTAL ALIGNERS, PROCEDURES FOR ALIGNING TEETH, AND AUTOMATED ORTHODONTIC TREATMENT PLANNING

(71) Applicant: CANDID CARE CO., New York, NY (US)

(72) Inventors: Daniel Michaeli, New York, NY (US); Chester Lynn Hurst, Austin, TX (US)

(73) Assignee: CANDID CARE CO., New York, NY (US)

(21) Appl. No.: 17/066,636

(22) Filed: Oct. 9, 2020

Related U.S. Application Data
(63) Continuation-in-part of application No. PCT/US2020/027633, filed on Apr. 10, 2020.
(60) Provisional application No. 62/832,550, filed on Apr. 11, 2019.

(51) Int. Cl. A61C 7/08; A61C 7/00; G06N 20/00

(52) U.S. Cl. CPC A61C 7/08; G06N 20/00; A61C 7/002

(57) ABSTRACT

A method, system, and apparatus for orthodontic treatment planning to align a patient's teeth, and dental appliance devices for aligning the patient's teeth based on the method. The method comprises performing pre-staging to evaluate a patient's general oral and periodontal health. Additionally, the method comprises performing a lower arch stage of treatment planning to define movement of at least one tooth of a lower arch, performing an upper arch stage of treatment planning to define movement of at least one tooth of an upper arch, and performing a final arch stage of treatment planning to define articulation of the lower and upper arches. At least one stage is based on a predetermined prior treatment plan. Dental appliances can be fabricated having geometries determined based on at least one stage. Patient wear of successive dental appliances manipulates the patient's teeth to a final, aligned teeth arrangement, as planned by the method.

### CROSS REFERENCE TO RELATED APPLICATION

This application is a continuation-in-part (CIP) of International Application No. PCT/US2020/027633, filed Apr. 10, 2020, and claims the benefit of priority of that International Application and U.S. Provisional Application No. 62/832,550, filed Apr. 11, 2019. The International Application and the Provisional Application are hereby incorporated by reference, as if set forth fully herein.

### BACKGROUND

Traditionally, metal braces, temporary anchorage devices (TADs), Class II connectors, headgear, elastics, wires and the like were used to reposition a patient's teeth over time, in order to provide better teeth alignment. Metal braces, for example, include brackets that affix to a patient's teeth. Wires are threaded through slots in the brackets and are maintained in connection with the brackets by way of rubber bands. Typically, the brackets include stainless steel. The wires apply a constant force that causes movement and alignment of the patient's teeth.

However, the use of metal braces and other mechanisms mentioned above to reposition teeth is uncomfortable and oftentimes painful to the patient, unsightly, and requires time consuming and costly patient visits to a treating orthodontist. Moreover, in such traditional methods, the treating orthodontist prescribes a desired tooth arrangement, but without precise calculations of factors such as tooth forces, avoidance of tooth collisions, and the like. As a result, traditional tooth alignment efforts often lack sufficient precision to enable efficient tooth alignment.

Clear dental aligners are orthodontic appliance devices that are used to adjust teeth. When worn for a particular amount of time (e.g., 22 hours per day over two weeks), a dental aligner slowly moves a patient's teeth to positions that were prescribed by an orthodontist or dentist. Dental aligners are typically manufactured based on the assessment of diagnostic records, such as intra oral and extra oral photographs, study models (virtual or otherwise), panoramic radiographs (x-rays), and generally are formed of transparent plastic.

U.S. Pat. No. 8,070,487 B2 additionally refers to a method and apparatus for fitting a set of upper teeth to lower teeth in a masticatory system by generating a computer representation of the system and computing an occlusion based on intersections in the computer representation of the system.

European Patent 1876990B1 describes methods of moving a subject's teeth wherein one or more aligners are provided to a subject to wear, so that the aligners may exert force to move the subject's teeth. The aligners can be designed as part of a series of aligners to be worn, and the series may be determined based on the subject's initial teeth position, and based on input from a user (e.g., an orthodontist).

Orthodontic aligners were first conceived in the 1940's by orthodontist Dr. H. D. Kesling's. Dr. Kesling's so-called “tooth positioner” was an appliance made from rubber that, when in use, enclosed both teeth quadrants, looking similar to a mouth guard typically used in sports. Over the years, clear plastic shells were developed and used heavily for tasks such as retaining teeth following treatment and protecting teeth from sports injuries and the like. Manufacturing of such devices often was a task performed by dental laboratories. Techniques for retaining and even moving teeth were manually-driven, typically involved the creation of physical models, and required creation of a multitude of positive and negative copies of dentition.

Orthodontic treatment planning software is well known in the art. In the late 1990's, Christi and Wirth developed digital automated tools based upon computer graphics for automating these processes. Align Technology's CLINCHECK® software is a descendant of those early developments. Other example existing treatment planning software includes Dentsply Sirona's SURESMILE®, Ormco's SPARK® and 3Shape's ORTHOANALYZER®. Using a 3D graphical representation of an impression, these tools digitally rotate, translate, and proclinate individual tooth objects from a starting position to an ending position. A main goal is to move teeth gradually and deliberately towards a desirable final tooth position.

Presently, there remains a wide variety of philosophies for exactly how to optimize orthodontic tooth movement. As such, while certainly there are guidelines and some general rules of thumb, technicians follow a multitude of clinical protocols, guided by the treating prescription and teaching philosophies of trainers and contemporaries. Also, optimizing treatment methodology typically relies on outcome data. Historically, large stakeholders have lacked outcome data available to assist in the development of a unified treatment philosophy. Thus, while the tools for moving virtual tooth objects are well developed, strategies for tooth movement are scientifically untested and based more on trial and error rather than large prospective research studies.

With treatment planning software, the clinician or technician designate typically begins by uploading initial starting position stereolithography STL data derived from a digital or physical impression of the upper and lower arch. The technician, upon prescription from an orthodontically trained dentist, suggests a preferred ending position and designs incremental treatment steps that would move the teeth accordingly. Such a process is manual, time-consuming, fraught with error, and, as a result, variable depending upon the personal preferences of the clinician.

U.S. Pat. No. 9,152,767 B2 (ClearConnect Holdings, Inc.) is directed to a method for treating an orthodontic condition. The method includes receiving patient data (such as through a website), accessing a database having information derived from patient treatments, generating a model of an orthodontic condition defining one or more anatomic features of a set of teeth, identifying a diagnosis of an orthodontic condition, and identifying a treatment regimen for the diagnosis. U.S. Pat. No. 9,152,767 B2 also refers to a method including tagging an anatomic feature with an electronic identifier and automatically generating a tooth setup. A system includes a server and a database, which can include information relating to patient treatments, and a website for receiving patient data. U.S. Pat. No. 8,070,487 B2, referred to above, also discloses that a system can include an electronic model representing anatomic features of a patient's teeth and an application adapted to identify a diagnosis and a treatment regimen for an orthodontic condition, which can include executing artificial intelligence and/or other algorithms. See also related U.S. Pat. Nos. 8,856,053 and 8,478,698.

U.S. Patent Application Publication No. 2019-0192258 A1 (Clearline.Co.Ltd.) discloses a stepwise automatic orthodontic system and method using an artificial intelligence technique. The method includes scanning a dental state of a patient by using an intraoral scanner, allowing a server to determine to which group of grouped data of the database the scanned dental data belong, and allowing the server to refer to data of the determined group, move a tooth needing orthodontics gradually, and generate a predictive digital orthodontic dental data set. The method also includes allowing the server to transmit the orthodontic-processed digital orthodontic dental data set of a patient to a 3D printer, and allowing the 3D printer to generate and output a dental orthodontic model, and generating a clear aligner by vacuum-compressing a transparent synthetic resin plate to the generated dental orthodontic model through a vacuum former. The orthodontic patient is clustered or grouped through an unsupervised learning based on the good orthodontic data excluding personal information of the patient, and the tooth moving plan for orthodontics through repeated reinforcement learning satisfying the orthodontic limit condition suggested by the grouped data and the orthodontics textbook for respective steps.

U.S. Patent Application Pub. No. 2019-0125274 A1 (Dental Monitoring) relates to a method for predicting a future dental situation for a patient. The method includes acquiring historical data including previous time point and context parameter values. The method also includes acquiring at a time point all the data related to the current dental situation, such as the current time point, context parameter values at the current time point, statistical analysis of the historical data, and the current data, to predict, at a future time point, at least one future dental situation for the current patient. Depending on the future dental situation, (re)evaluation can be performed of the benefit of an orthodontic treatment. According to the publication, steps may include creating a three-dimensional digital reference model, acquiring at least one two-dimensional image, analysing each updated image and creation, searching, for each updated image, and collecting data relative to the updated reference model and relative to the orthodontic appliance.

A publication entitled “Orthodontic Treatment Planning based on Artificial Neural Networks”, by Peilin et al., Nature.com, Scientific Reports, pp. 1-9 (published online on Feb. 14, 2019) refers to a study involving multilayer perceptron artificial neural networks used purportedly to predict orthodontic treatment plans, including determining extraction-nonextraction, extraction patterns, and anchorage patterns. The publication purports that a neural network can output feasibilities of several applicable treatment plans, offering orthodontists flexibility in making decisions.

Traditionally, treatment methodologies have been haphazard and sequenced based on clinician preference. Traditional treatment methodologies were planned prior to treatment and only modified if the treatment was identified as problematic during a patient visit or if required by a clinical event such as a mid-course collision. Outcome data was not collected, nor was it available as a learning mechanism for future treatments.

### SUMMARY

A method, apparatus, system, and computer-readable medium, are provided for orthodontic treatment planning. According to one example embodiment herein, the method comprises performing a lower arch stage of treatment planning to define movement of at least one tooth of a lower arch, performing an upper arch stage of treatment planning to define movement of at least one tooth of an upper arch, and performing a final arch stage of treatment planning to define articulation of the lower and upper arches. A next step includes providing dental appliances having geometries determined based on at least one of the performed lower arch stage of treatment planning, the upper arch stage of treatment planning, and the final arch stage of treatment planning.

In one example embodiment herein, the method further comprises performing pre-staging to evaluate a patient's general oral and periodontal health.

The upper arch stage of treatment planning, the lower arch stage of treatment planning, and the final arch stage of treatment planning, are performed to align teeth of the upper and lower arches, according to one example embodiment herein.

In an additional example embodiment herein, the upper and lower arches are included in a computer model. Also in one example embodiment herein, the geometries of the dental appliances differ from one another.

The dental appliances are wearable by a patient, and successive wears by the patient of respective ones of the dental appliances manipulate teeth of the patient to a final teeth arrangement.

Also in one example embodiment herein, the movements avoid tooth collisions. In an additional example embodiment herein, at least one of the upper arch stage of treatment planning or the lower arch stage of treatment planning includes a distalization to correct a malocclusion.

Also, in one example embodiment herein, at least one of the performings is performed using an electronic user interface that depicts the upper and lower arches in the computer model.

Also in an example embodiment herein, tooth movement includes one or more of displacing, rotating, aligning, a translation, distalization, expansion, proclination, lingualization, mesialization, tipping, torqueing, intrusion, and extrusion of at least one tooth. Also, in an example embodiment herein, at least one tooth movement is in accordance with at least one of a prescribed curve of Spee or a prescribed curve of Wilson. In a further example embodiment herein, the final arch stage of treatment planning includes one or more of performing a change in crown torque on at least one tooth, performing aesthetic positioning of at least one tooth, and substantially avoiding interproximal reduction.

In accordance with a further example aspect herein, a system is provided for positioning a patient's teeth. The system comprises a plurality of dental appliances. Each appliance has respective geometries determined based on at least one of a lower arch stage of treatment planning, an upper arch stage of treatment planning, or a final arch stage of treatment planning. The lower arch stage of treatment planning defines movement of at least one tooth of a lower arch, the upper arch stage of treatment planning defines movement of at least one tooth of an upper arch, and the final arch stage of treatment planning defines articulation of the lower and upper arches. The dental appliances are wearable on teeth of a patient, and successive wears on the teeth of the patient of respective ones of the dental appliances manipulate the teeth of the patient to a final teeth arrangement. In one example embodiment herein, the dental appliances manipulate the teeth of the patient without causing tooth collisions, and, in the final teeth arrangement, the teeth of the patient are substantially aligned.

According to still another example embodiment herein, a method for orthodontic treatment planning is provided. The method comprises providing a dental appliance having a geometry based on a lower arch stage of treatment planning defining movement of at least one tooth of a lower arch, providing a dental appliance having a geometry based on an upper arch stage of treatment planning defining movement of at least one tooth of an upper arch, and providing a dental appliance having a geometry based on a final arch stage of treatment planning defining articulation of the lower and upper arches. According to one example embodiment herein, at least one of the lower arch stage of treatment planning, the upper arch stage of treatment planning, or the final arch stage of treatment planning is based at least in part on a predetermined prior treatment plan. The upper arch stage of treatment planning, the lower arch stage of treatment planning, and the final arch stage of treatment planning align teeth of the upper and lower arches.

In one example embodiment herein, the dental appliances are provided by controlling a manufacturing device to fabricate the dental appliances.

In still another example embodiment herein, the geometries of the dental appliances differ from one another, and the upper arch stage of treatment planning involves fitting teeth of the upper arch to teeth of the lower arch, while using the lower arch as a reference.

In an example embodiment herein, the predetermined prior treatment plan correlates to a patient for whom the method is performed, and the predetermined prior treatment plan is for a different patient. The predetermined prior treatment plan, in one example herein, correlates to the patient by virtue of at least one of a condition, demographic, or anatomy, of the patient correlating to at least one of a condition, demographic, or anatomy, of the different patient.

In an additional example embodiment herein, the predetermined prior treatment plan is a machine learned treatment plan.

Also in one example embodiment herein, at least one of the upper arch, the lower arch, or dental appliances are computerized models.

Another example embodiment herein will now be described. In this example, a system is provided for positioning a patient's teeth. The system comprises a plurality of dental appliances having geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches. The dental appliances are wearable on teeth of a patient, and successive wears on the teeth of the patient of respective ones of the dental appliances manipulate the teeth of the patient to a final teeth arrangement.

According to an example embodiment herein, at least one of the lower arch stage of treatment planning, the upper arch stage of treatment planning, or the final arch stage of treatment planning is based at least in part on a predetermined prior treatment plan. The predetermined prior treatment plan is for a different patient and correlates to the patient by virtue of at least one of a condition, demographic, or anatomy, of the patient correlating to at least one of a condition, demographic, or anatomy, of the different patient.

In an example embodiment herein, the predetermined prior treatment plan is a machine learned treatment.

According to still a further example embodiment herein, a system is provided for orthodontic treatment planning for a patient. The system comprises a processor, and a storage medium storing computer-readable instructions that, when executed by the processor, cause the processor to perform a method. The method comprises providing dental appliances having geometries defining a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches.

In one example embodiment herein, at least one of the lower arch stage of treatment planning, the upper arch stage of treatment planning, or the final arch stage of treatment planning is based at least in part on a predetermined prior treatment plan. The predetermined prior treatment plan is for a different patient and correlates to the patient by virtue of at least one of a condition, demographic, or anatomy, of the patient correlating to at least one of a condition, demographic, or anatomy, of the different patient. The predetermined prior treatment plan can be a machine learned treatment plan.

The foregoing system also can comprise a user interface coupled to the processor and arranged to present a computer model of at least one of the lower arch or the upper arch to a user. Additionally, the system can further comprise a manufacturing device coupled to the processor, wherein the processor provides the dental appliances by controlling the manufacturing device to cause the manufacturing device to fabricate physical dental appliances wearable by the patient.

The dental appliances are wearable on teeth of the patient, and wherein successive wears on the teeth of the patient of respective ones of the dental appliances manipulate the teeth of the patient to a final teeth arrangement. The geometries of the dental appliances, when worn by the patient, cause movement of at least one tooth of a lower arch of the patient, movement of at least one tooth of an upper arch of the patient, and articulation of the lower and upper arches of the patient.

In still a further example embodiment herein, a system is provided comprising a first dental appliance having a first geometry, a second dental appliance having a second geometry, and a third dental appliance having a third geometry. The system is produced by a method comprising performing a lower arch stage of treatment planning to define movement, to be effected by the first geometry, of at least one tooth of a lower arch, performing an upper arch stage of treatment planning to define movement, to be effected by the second geometry, of at least one tooth of an upper arch, and performing a final arch stage of treatment planning to define articulation, to be effected by the third geometry, of the lower and upper arches.

According to an example embodiment herein, at least one of the lower arch stage of treatment planning, the upper arch stage of treatment planning, or the final arch stage of treatment planning is based at least in part on a predetermined prior treatment plan.

In still another example embodiment herein, a computer-readable storage medium is provided. The medium stores instructions which, when executed by a computer processor, cause the computer processor to perform a method for orthodontic treatment planning for a patient. The method comprises providing dental appliances having geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches.

In an example embodiment herein, at least one of the lower arch stage of treatment planning, the upper arch stage of treatment planning, or the final arch stage of treatment planning is based at least in part on a predetermined prior treatment plan.

### BRIEF DESCRIPTION OF THE DRAWINGS

FIG. 1 illustrates a method according to an example aspect herein.

FIG. 2 illustrates a method of performing lower arch pre-staging, according to a step of the method of FIG. 1.

FIG. 3 illustrates a method of performing upper arch pre-staging, according to a step of the method of FIG. 1.

FIG. 4 is a diagram of a data processing system 400 according to an example embodiment herein.

FIG. 5 shows a 3D model of a patient's lower teeth.

FIG. 6 illustrates a dental aligner constructed according to an example aspect herein.

FIG. 7 represents lingualization of teeth of an arch, according to an example embodiment herein.

FIG. 8 represents proclination of teeth of an arch, according to an example embodiment herein.

FIG. 9 represents expansion of an arch, according to an example embodiment herein.

FIG. 10 represents mesialization of an arch, according to an example embodiment herein.

FIG. 11 represents distalization of an arch, according to an example embodiment herein.

FIG. 12 represents translation of a tooth, according to an example embodiment herein.

FIG. 13 represents rotation of a tooth, according to an example embodiment herein.

FIG. 14 represents extrusion of a tooth, according to an example embodiment herein.

FIG. 15 represents intrusion of a tooth, according to an example embodiment herein.

FIG. 16 represents torqueing of a tooth, according to an example embodiment herein.

FIG. 17 represents root tipping of a tooth, according to an example embodiment herein.

FIG. 18 represents crown tipping of a tooth, according to an example embodiment herein.

FIG. 19 depicts an interface that includes a front view of a model of upper and lower arches of a patient, and controls for viewing the model, in a starting step of a treatment plan for aligning teeth.

FIG. 20 depicts an interface that includes a left side view of the model of upper and lower arches of the patient, and controls for viewing the model, in the starting step of a treatment plan for aligning teeth.

FIG. 21 depicts an interface that includes a right side view of the model of upper and lower arches of the patient, and controls for viewing the model, in the starting step of the treatment plan for aligning teeth.

FIG. 22 depicts an interface that includes the lower arch of the model, and controls for viewing the model, in the starting step of the treatment plan for aligning teeth.

FIG. 23 depicts an interface that includes the upper arch of the model, and controls for viewing the model, in the starting step of the treatment plan for aligning teeth.

FIG. 24 depicts an interface that includes a front view of the model of upper and lower arches of the patient, and controls for viewing the model, in a further step of the treatment plan for aligning teeth.

FIG. 25 depicts an interface that includes a left side view of the model of upper and lower arches of the patient, and controls for viewing the model, in the further step of the treatment plan for aligning teeth.

FIG. 26 depicts an interface that includes a right side view of the model of upper and lower arches of the patient, and controls for viewing the model, in the further step of the treatment plan for aligning teeth.

FIG. 27 depicts an interface that includes the lower arch of the model, and controls for viewing the model, in the further step of the treatment plan for aligning teeth.

FIG. 28 depicts an interface that includes the upper arch of the model, and controls for viewing the model, in the further step of the treatment plan for aligning teeth.

FIG. 29 depicts an interface that includes a front view of the model of upper and lower arches of the patient, and controls for viewing the model, in an additional step of the treatment plan for aligning teeth.

FIG. 30 depicts an interface that includes a left side view of the model of upper and lower arches of the patient, and controls for viewing the model, in the additional step of the treatment plan for aligning teeth.

FIG. 31 depicts an interface that includes a right side view of the model of upper and lower arches of the patient, and controls for viewing the model, in the additional step of the treatment plan for aligning teeth.

FIG. 32 depicts an interface that includes the lower arch of the model, and controls for viewing the model, in the additional step of the treatment plan for aligning teeth.

FIG. 33 depicts an interface that includes the upper arch of the model, and controls for viewing the model, in the additional step of the treatment plan for aligning teeth.

FIG. 34 depicts an interface that includes a front view of the model of upper and lower arches of the patient, and controls for viewing the model, in another step of the treatment plan for aligning teeth.

FIG. 35 depicts an interface that includes a left side view of the model of upper and lower arches of the patient, and controls for viewing the model, in the other step of the treatment plan for aligning teeth.

FIG. 36 depicts an interface that includes a right side view of the model of upper and lower arches of the patient, and controls for viewing the model, in the other step of the treatment plan for aligning teeth.

FIG. 37 depicts an interface that includes the lower arch of the model, and controls for viewing the model, in the other step of the treatment plan for aligning teeth.

FIG. 38 depicts an interface that includes the upper arch of the model, and controls for viewing the model, in the other step of the treatment plan for aligning teeth.

FIG. 39 illustrates a method according to another example aspect herein, involving use of artificial intelligence to optimize a patient orthodontic treatment plan.

FIG. 40 illustrates in greater detail a procedure, performed as part of the method of FIG. 39, for aligning teeth and providing dental aligners.

FIG. 41 illustrates a method of performing lower arch pre-staging, according to the procedure of FIG. 40.

FIG. 42 illustrates a method of performing upper arch pre-staging, according to the procedure of FIG. 40.

FIG. 43 shows in greater detail a database used in the method of FIG. 39, wherein the database stores content according to an example embodiment herein.

FIG. 44 illustrates in greater detail a procedure, performed as part of the method of FIG. 39, for determining whether at least one record of the database of FIG. 43 correlates to a present patient in a manner so as to be useful in treating the patient.

FIG. 45 illustrates training of a learning algorithm for optimizing a treatment plan, according to an example aspect herein.

Same reference numerals appearing in different ones of the figures represent the same components, although each component may not be described in detail herein with respect to the description of each separate figure.

### DETAILED DESCRIPTION

The inventors have developed novel and inventive methods and devices for repositioning and/or aligning a patient's teeth, to ensure greater accuracy, quality, and predictability in tooth alignments, while avoiding limitations associated with the use of traditional metal braces, wires, and the like for repositioning teeth. In one example embodiment herein, the method includes performing pre-staging, lower arch staging, upper arch staging, and final staging, and also can include manufacturing one or a series of dental appliances (e.g., such as dental aligners) based on at least one of the stagings. In one example embodiment herein, the pre-staging is performed to evaluate a patient's general oral and periodontal health, and the lower arch staging involves treatment planning to define movement of at least one tooth of a lower arch. Also in one example embodiment herein, the upper arch staging involves treatment planning to define movement of at least one tooth of an upper arch, and the final arch stage involves treatment planning to define articulation of the lower and upper arches. The upper arch stage, lower arch stage, and final arch stage (which, in one example embodiment, can be performed using a computer model) are performed to place the teeth in a final arrangement in which preferably the teeth of the upper and lower arches are aligned.

The dental appliances can be manufactured to have geometries determined based on at least one of the performed lower arch stage, upper arch stage, and final arch stage. The dental aligner(s) have geometries determined by the stagings to enable a patient's teeth to be repositioned/re-orientated as planned by the stagings, from an initial teeth arrangement, until the teeth have a final (prescribed aligned) arrangement. The aligners can be worn by the patient in order to reposition/re-orientate the patient's teeth, without requiring the use of metal braces, TADs, Class II connectors, headgear, elastics, wires and the like. Also, while conventionally it was challenging, if not impossible, to perform anterior-posterior/sagittal correction by anterior movement of the mandible, without using mechanisms such as headgear, elastics, TAD's or Class II correctors, the method(s) and aligners described herein enable such corrections to be performed without necessarily requiring the conventional mechanisms.

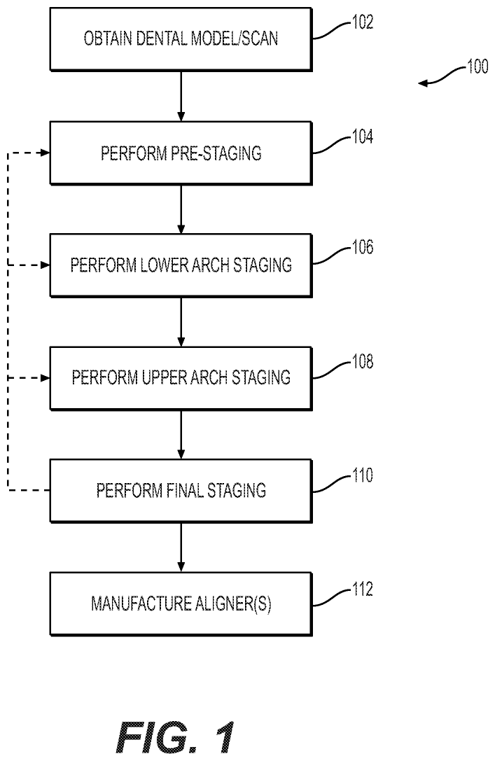

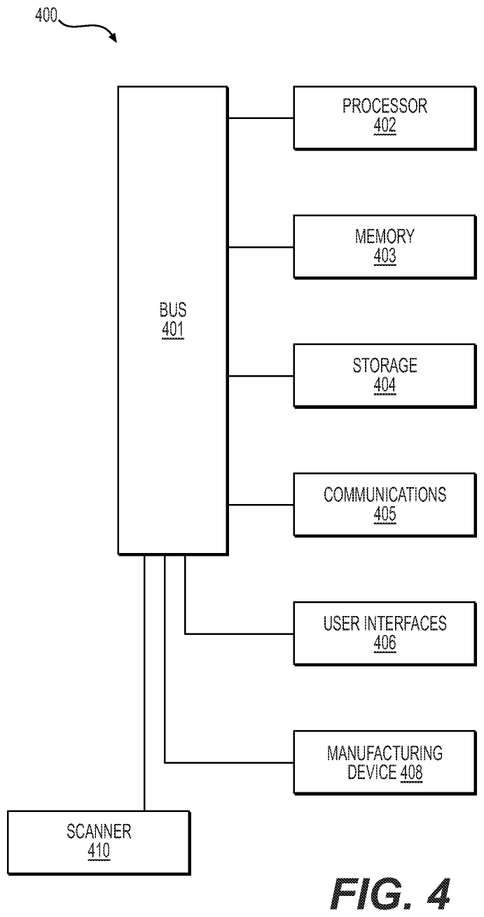

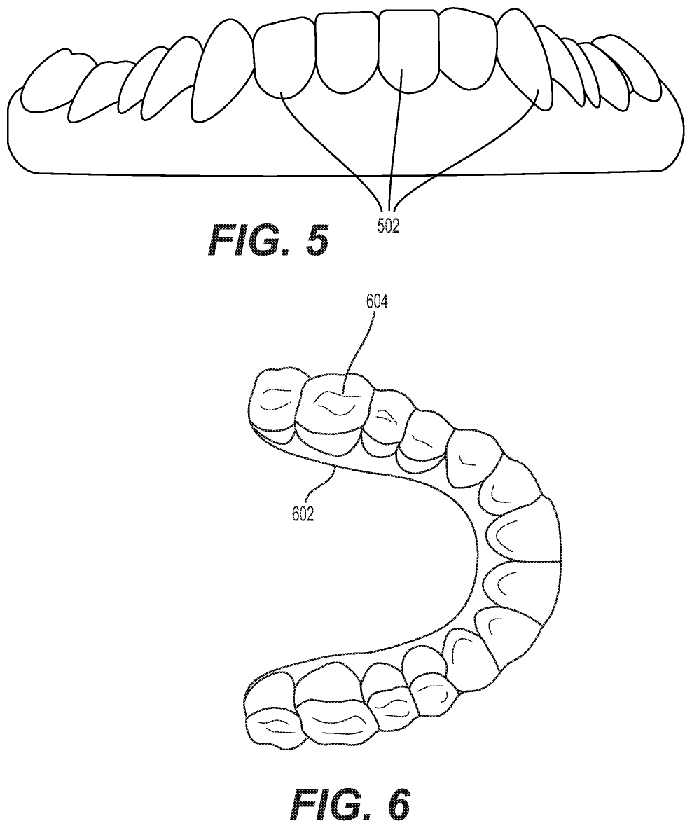

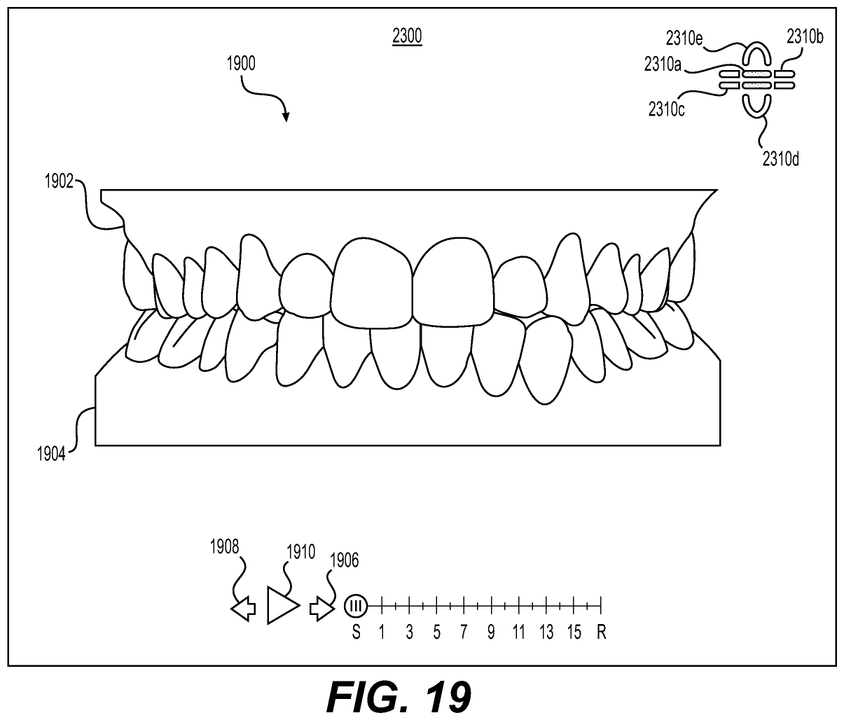

A method 100 according to an example aspect herein will now be described, with reference to FIG. 1. In step 102 a dental impression of a patient's dental arch is obtained. A dental impression is a negative imprint of hard (teeth) and soft tissues in a patient's mouth. Also in step 102, a positive reproduction (i.e., a cast or model) is then formed of the dental arch, including a reproduction of the teeth and soft tissue. Additionally in step 102, 3D scans are then taken (by, for example, scanner 410 of FIG. 4 to be described below) of the reproduction to provide digital data (also referred to herein as “scans” or “3D scans”) representing the reproduction. The 3D scans, which in one example can be included in one or more stereolithography (STL) files, can form a 3D computer model of the upper and lower arches of the patient, and the model can be viewed and manipulated by a user in virtual 3D space via a user interface (such as user-interface 406, e.g., a display, and/or 2300 to be described below). FIG. 5 shows an example of a displayed 3D model of a patient's lower arch. (FIG. 19 represents an example interface 2300 that shows a computer model 1900 (e.g., 2D or 3D) of an upper and lower arch at a starting step S of a treatment procedure, as will be described below). In another example embodiment, the positive reproduction need not be formed (in step 102), and instead (using, e.g., scanner 410) a direct digital impression of the patient's arch can be obtained in step 102, or the physical dental impression is digitized for being employed in the steps below.

Pre-staging is then performed, in step 104. In one example embodiment herein, pre-staging 104 includes an orthodontist or specialist reviewing diagnostic records, such as, by example and without limitation, individual scans or a collage of scans, upper/lower arch STL files, 3D scans, 3D models (e.g., such as those described above), the patient's medical/dental history, the absence/presence of third molars or other teeth, the patient's general oral health and periodontal health, extra-oral photography and the like. Pre-staging can be performed with an eye towards determining which upper/lower tooth movements are possible or desired to be effected for the patient, in order to provide the patient with an optimal tooth alignment in terms of function and/or aesthetics.

After step 104, lower arch staging 106 is performed. In one example embodiment herein, lower arch staging 106 preferably is performed prior to upper arch staging 108 (to be described below), and the lower arch staging 106 involves treatment planning to define movement of at least one tooth of a lower arch, for purposes of overall teeth alignment. For a patient's lower arch, there is less bone than in the upper arch, and the medullary bone is in a trough bordered buccal/lingually by a cortical bone, resulting in limited tooth movement options relative to upper arch teeth. Performing lower arch staging 106 before upper arch staging 108 helps to establish the lower arch/teeth first, thereby enabling a best fit to be achieved of the upper teeth to the lower teeth when steps 108 and 110 are later performed.

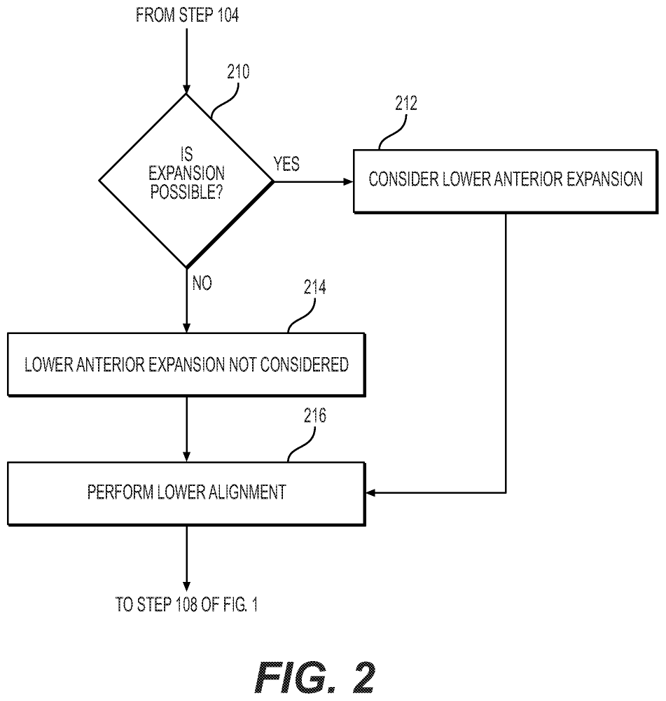

FIG. 2 shows in greater detail an example of how lower arch pre-staging according to step 106 is performed, according to one example embodiment herein. In step 210 a determination is made as to whether lower anterior/buccal expansion is possible. By example only, this determination can be based on an evaluation of the periodontal health (e.g., the presence of plaque, calculus, inflammation/recession or the like) of the patient's lower teeth/arch, and, in one example embodiment, is performed based on information evaluated/obtained in step 104. If it is determined that the patient's lower teeth/arch are/is healthy (“Yes” in step 210), then lower expansion or repositioning of the lower teeth can be considered (step 212), and the procedure proceeds to step 216, which will be described below. On the other hand, if it is determined that the patient's lower teeth/arch are/is not healthy (“No” in step 210), then lower anterior expansion should not be considered, and other procedures can be considered such as, by example and without limitation, buccal expansion and/or sequential step distalization, or it can be decided to not treat the lower teeth/arch (step 214).

Step 216 is performed after either of steps 212 and 214 is performed. In step 216, the user can operate an input user interface (such as interface 406 and/or 2300 to be described below) to manipulate the 3D model and one or more of the lower teeth 500 (FIG. 5) and to perform various procedures in an effort to plan to manipulate, and/or manipulate, the positions and orientations of one or more lower teeth 502 of the model, such that, after all steps 106 to 108 of FIG. 1 are performed, the upper and lower teeth will be optimally aligned (and placed in a prescribed final arrangement) with regard to function and aesthetics. Step 216 can include various considerations (e.g., based on information obtained in step 104), functions and procedures. By example only and without limitation, step 216 can include one or more of moving (e.g., displacing) and/or rotating one or more lower teeth (e.g., starting with a molar, in one example), aligning one or more lower teeth, translation, distalization, expansion (where deemed appropriate, such as in a case of “Yes” in step 210), proclination, lingualization, and/or mesialization of one or more lower teeth, and the like, to establish a symmetrical form and dental midline in the 3D model. Step 216 also can include considering and/or performing tipping, torque (torqueing), intrusion, and/or extrusion to achieve those goals.

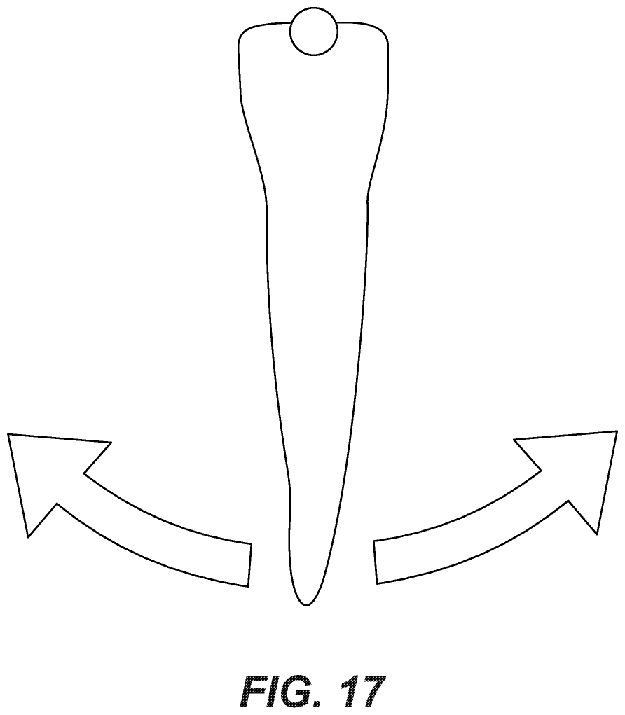

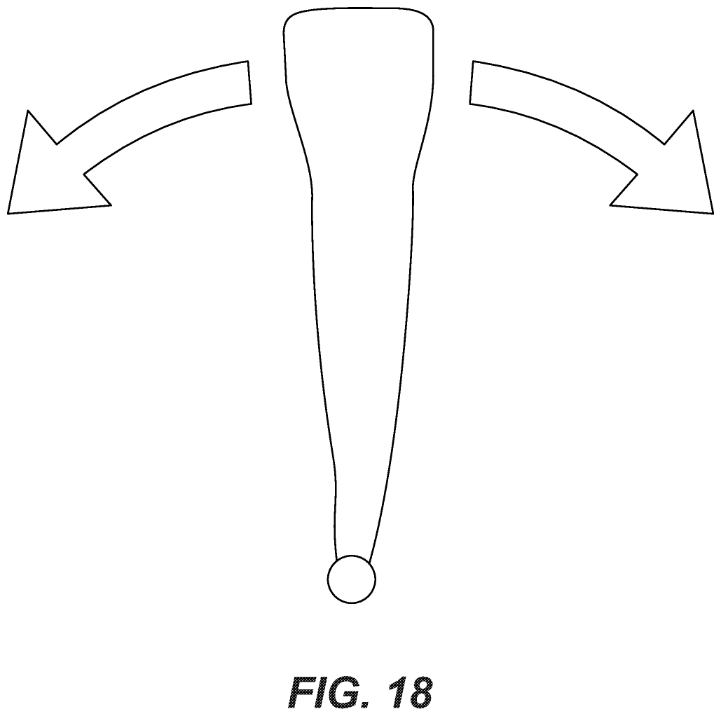

Tipping can include, by example and referring to FIG. 18, crown tipping, which is the tilting of the crown of a tooth without moving the apex of the root. Tipping also can include, by example, root tipping. Root tipping, an example of which is represented in FIG. 17, involves tilting of a root of a tooth without moving the apex of the crown. Torqueing has evolved from fixed appliances and, although there is no wire and bracket, the concept can be applied to clear aligners. In clear aligner therapy, and referring for example to FIG. 16, to torque a tooth is to move the tooth buccolingually around the centerpoint, so the crown and root move in opposite directions. It is the twisting force which is traditionally required to adjust the inclination of a crown.

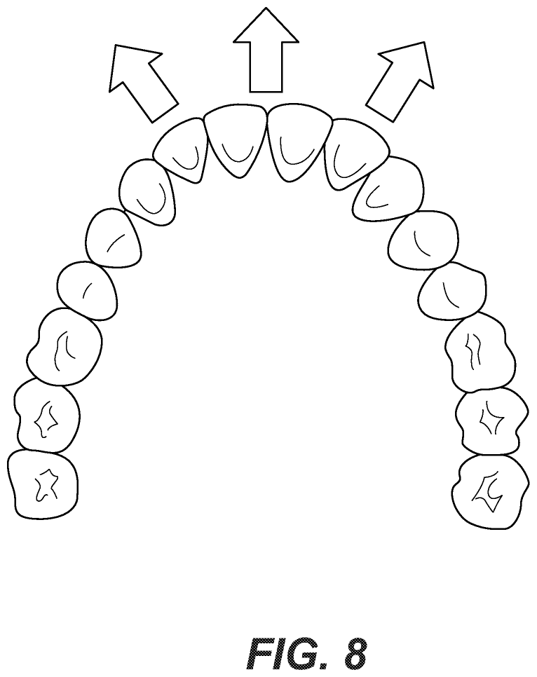

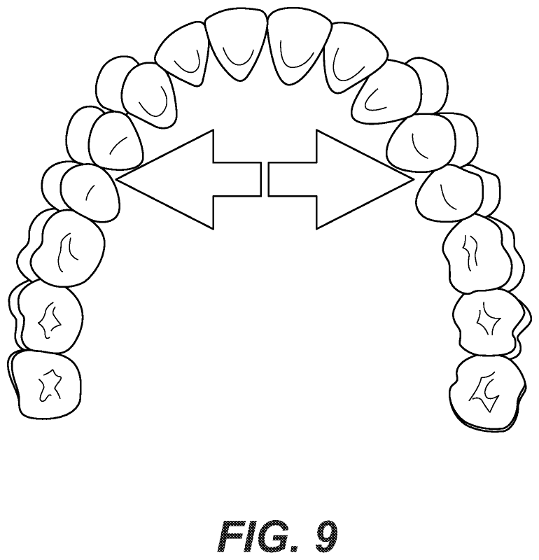

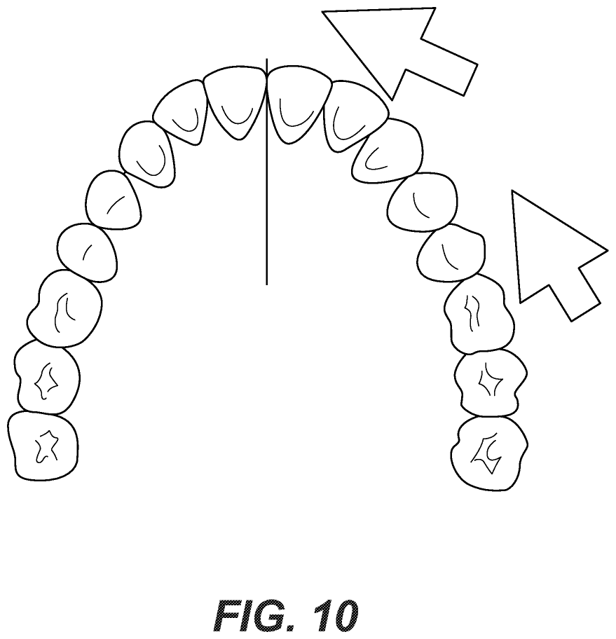

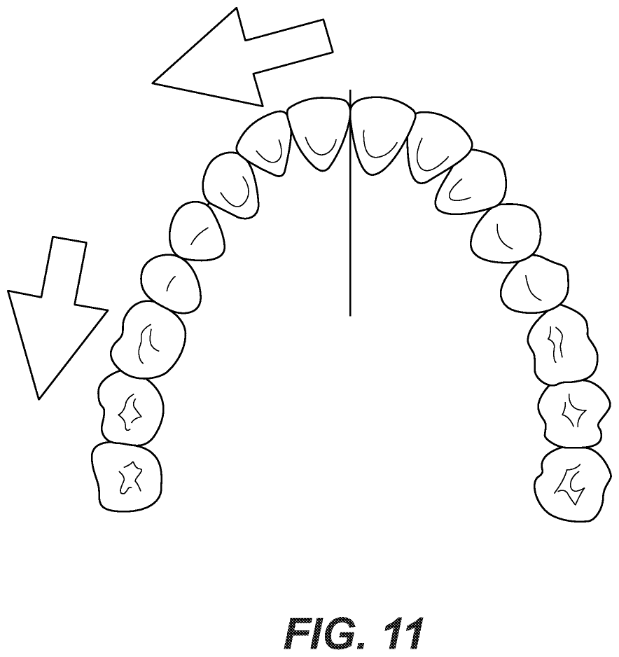

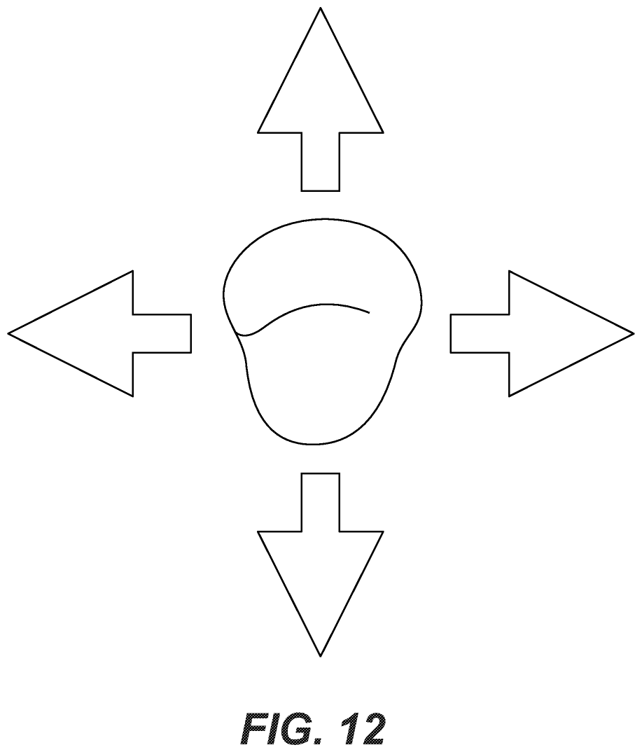

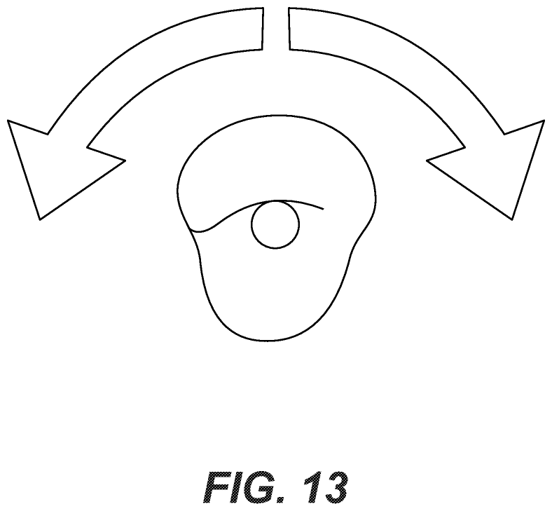

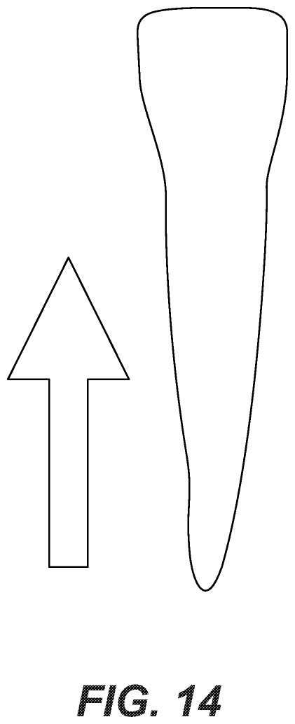

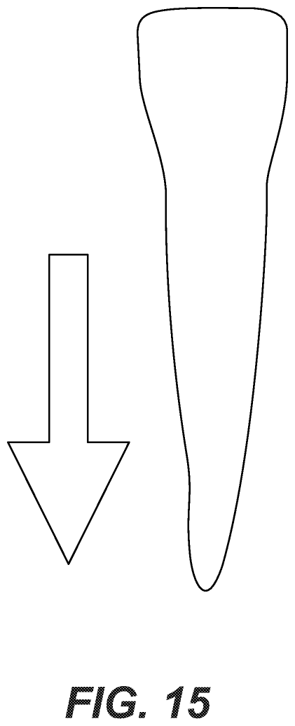

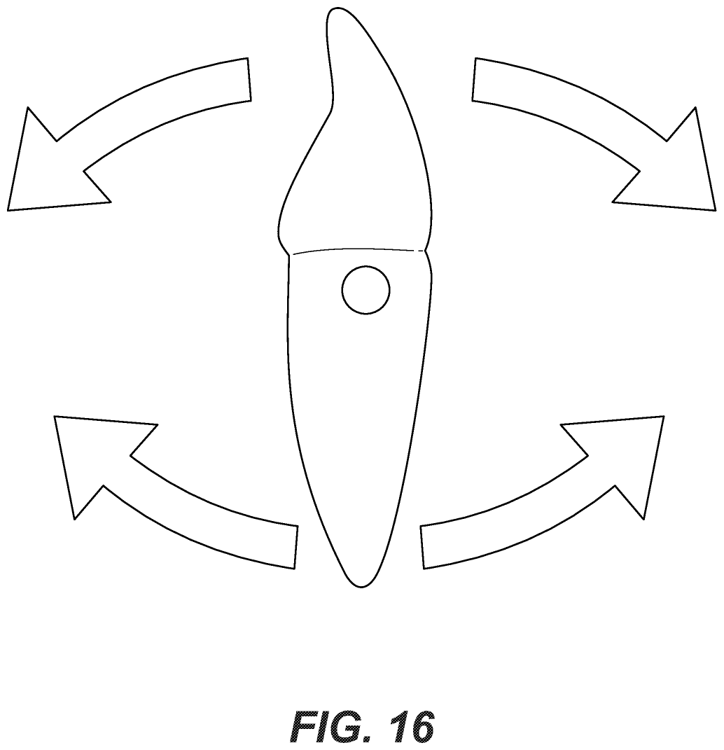

Referring to FIG. 15, intrusion can involve moving a tooth into supporting structures, and extrusion is moving of a tooth out of a supporting structure (FIG. 14). Rotation can include, by example and referring to FIG. 13, turning of a tooth about its long axis. Translation can include, for example and referring to FIG. 12, shifting a tooth along an occlusal plane without changing an orientation of the long axis. Distalization can include, by example and referring to FIG. 11, moving a tooth along the occlusal plane away from the midline. Mesialization can include, by example and referring to FIG. 10, moving a tooth along the occlusal plane towards the midline. Expansion includes, by example and referring to FIG. 9, moving posterior teeth outwards away from the midline. Proclination includes, by example and referring to FIG. 8, tipping the crown of anterior teeth labially.

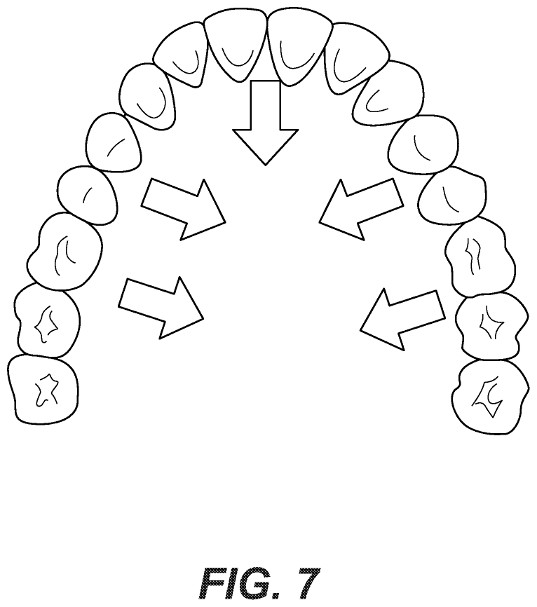

Lingualization can include, by example and referring to FIG. 7, moving teeth towards the tongue side of the arch. Step 214 and/or 216 also can include considering factors such as the curve of Spee, and/or the curve of Wilson of the patient, in manipulating and/or determining how one or more teeth should be manipulated as described above (in step 216). Also, step 216 can include performing Class III anterior-posterior/sagittal corrections, which in one example can be addressed in the lower arch with sequential step distalization. Step 216 also can include, in determining how one or more lower teeth should be manipulated as described above, determining a maximum displacement of the one or more teeth in the lower arch, determining an amount of force that should be applied to one or more teeth in order to move the teeth, determining an amount and/or angle of displacement and/or a travel path of one or more teeth, determining a length of time that the patient should wear an aligner to effect the movement, performing lower anterior expansion (in the case of “Yes” in step 210), determining which teeth should be anchors and which ones to move, performing buccal expansion and/or sequential step distalization, or deciding not to treat (in the case of “No” in step 210), and/or the like. In one example embodiment herein, step 216 also is performed such that mesio-distal contact collisions are avoided or substantially minimized. Each of the foregoing can be based, in one example embodiment, upon results obtained in pre-staging step 104.

An assessment (e.g., an automatic assessment or by an orthodontist/technician) of result(s) of step 216 can then be performed. According to an example aspect herein, steps 214 and 216 are performed without using or considering using attachments, interproximal reduction (IPR), buttons, elastics, metal braces, wires, and the like, and, in one example embodiment, the steps are performed to avoid or substantially minimize mesio-distal contact collisions.

After step 216 is performed, upper arch staging is performed in step 108 (FIG. 1). Upper arch staging 108 involves treatment planning to define movement of at least one tooth of an upper arch, for purposes of overall teeth alignment. Since the upper arch has more medullary bone than the lower arch, tooth movements are less limited, so the lower arch will now serve as a template for where to position the upper teeth.

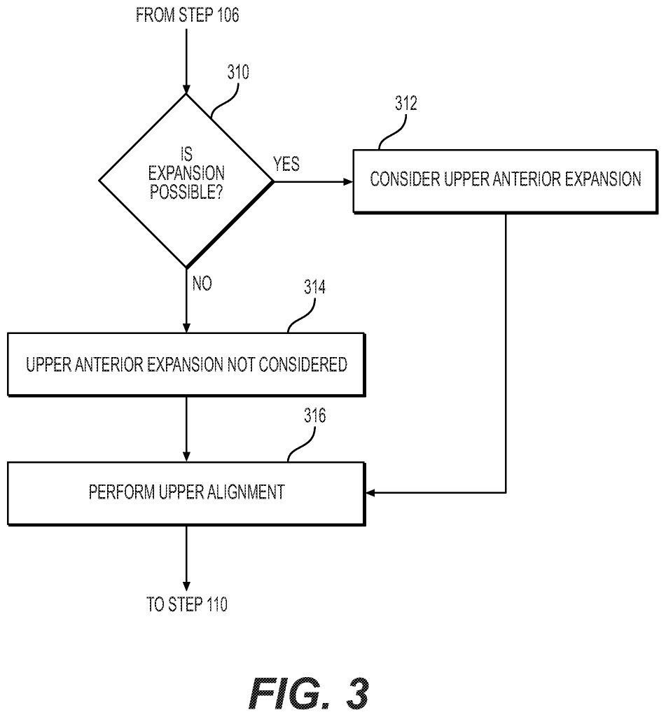

FIG. 3 shows in greater detail an example of how upper arch pre-staging of step 108 is performed, according to one example embodiment herein. In step 310 a determination is made as to whether upper anterior/buccal expansion is possible. By example only, this determination can be based on an evaluation of the periodontal health (e.g., the presence of plaque, calculus, inflammation/recession or the like) of the patient's upper teeth/arch, and, in one example embodiment, is performed based on information evaluated/obtained in step 104. If it is determined that the patient's upper teeth/arch are/is healthy (“Yes” in step 310), then upper expansion or repositioning of the upper teeth can be considered (step 312), and the procedure proceeds to step 316, which will be described below. On the other, if it is determined that the patient's upper teeth/arch are/is not healthy (“No” in step 310), then upper anterior expansion should not be considered, and other procedures can be considered such as, by example and without limitation, sequential step distalization, or it can be decided not to treat the upper teeth (step 314).

Step 316 is performed after either of steps 312 and 314 is performed. In step 316, the user can operate an input user interface (such as interface 406 to be described below) to manipulate the 3D model and one or more upper teeth and to perform various procedures in an effort to plan to manipulate, and/or manipulate, the positions and orientations of one or more of the upper teeth of the model, such that, after steps 106 to 108 of FIG. 1 are performed, the upper and lower teeth will be optimally aligned (and placed in a prescribed final arrangement) with regard to function and aesthetics. Step 316 can include various considerations (e.g., based on information obtained in step 104), functions, and procedures. By example only and without limitation, step 316 can include one or more of moving (e.g., displacing) and/or rotating one or more upper teeth (e.g., starting with a molar, in one example), aligning one or more upper teeth, translation, distalization, expansion (where deemed appropriate, such as in a case of “Yes” in step 310), proclination, lingualization, and/or mesialization of one or more upper teeth, and the like, to establish a symmetrical form and dental midline in the 3D model. Step 316 also can include considering and/or performing tipping, torque (torqueing), intrusion, and/or extrusion to achieve those goals. Also, step 316 (and/or 314) can include considering factors such as the curve of Spee, and/or the curve of Wilson of the patient, in manipulating and/or determining how one or more teeth should be manipulated as described above (in step 316). Also, step 316 can include performing Class I/II anterior-posterior/sagittal corrections, which in one example can be addressed in the upper arch with buccal expansion and/or sequential step distalization.

Step 316 also can include, in determining how one or more upper teeth should be manipulated as described above, determining a maximum displacement of the one or more teeth in the upper arch, determining an amount of force that should be applied to one or more teeth in order to move the teeth, determining an amount and/or angle of displacement and/or a travel path of one or more teeth, determining a length of time that the patient should wear an aligner to effect the movement, performing upper anterior expansion (in the case of “Yes” in step 310), determining which teeth should be anchors and which ones to move, performing buccal expansion and/or sequential step distalization, or not treating the teeth (in the case of “No” in step 310), and/or the like, for the upper arch. In one example embodiment herein, step 316 also is performed in order to avoid (or substantially minimize) mesio-distal contact collisions. Also, in one example embodiment herein, step 316 can include determining if anterior/posterior bite ramps would be useful to mitigate deep bites (anterior) or open bites (posterior), and such ramp(s) can be considered/employed in the model as deemed suitable. Each of the foregoing can be based, in one example embodiment, upon results obtained in pre-staging step 104 (and/or lower staging step 106).

An assessment (e.g., an automatic assessment or by an orthodontist/technician) of result(s) of step 316 can be performed. According to an example aspect herein, the method of FIG. 3 is performed without using or considering using attachments, interproximal reduction (IPR), buttons, elastics, metal braces, wires, and, in one example embodiment, the method is performed to avoid or substantially minimize mesio-distal contact collisions.

After step 316, the method of FIG. 1 is returned to and step 110 is performed. Step 110 includes performing final staging articulation/occlusion, and involves treatment planning to define articulation of the lower and upper arches. Step 110 is performed to confirm that staging inter occlusal collisions are compatible with tooth movement and post staging occlusal collisions are both functional and stable, and to confirm that the upper and lower teeth are sufficiently aligned (and placed in a final, prescribed arrangement).

In one example embodiment herein, no IPR preferably is performed, and, in lieu of spacing in one arch and/or performing IPR in the other arch, a change in crown torque on the upper and lower anterior teeth can be performed, preferably to a level sufficient enough to close spaces in one arch and avoid IPR in the opposite arch. Oftentimes there is an anterior inclination (torque) problem, rather than a Bolton Discrepancy. Also in one example embodiment herein, step 110 can include performing aesthetic/artistic positioning of the upper/lower anterior teeth via distal root/mesial crown angulation.

In the foregoing manner, the position, orientation, and alignment of the teeth of the 3D model can be optimized in terms of function and aesthetics and the teeth can be placed in a prescribed final arrangement. In step 112 of FIG. 1, electronic models of one or more dental aligners can be generated, and then the physical aligners can be manufactured, wherein the manufactured aligners have structures that enable the patient's teeth to be incrementally repositioned and/or re-orientated in a manner as planned for/determined in steps 106-110 such that the patient's teeth can be optimally aligned in terms of function and aesthetics, and placed in the prescribed final arrangement. In one example embodiment, the dental aligners are transparent, and are formed of a polymer, plastic or other suitable material. In example embodiments herein, the dental aligners are formed by a manufacturing device (e.g., such as manufacturing device 408 of FIG. 4 to be described below) (e.g., 3D printer) which receives output signals from a computer processor (such as processor 402 described below) defining commands, and positions/orientations of upper and lower teeth, as determined in steps 106-108 (and/or as defined by the generated electronic models of the dental aligners), such that the manufacturing device forms corresponding aligners with geometries that, when each respective aligner is worn for a respective prescribed/predetermined amount of time by the patient, one or more respective teeth are repositioned/re-orientated over the time period in the manner defined by the aligner geometry and the corresponding signal(s) (and electronic models). By virtue of the patient wearing the aligners on his/her teeth, one or more teeth undergo a cumulative translation after being moved cumulatively by the incrementally-worn aligners. Each aligner (a representation of one of which is shown in FIG. 6) has a tooth receiving cavity 602 having a geometry 604 corresponding to an intermediate or final tooth arrangement intended for the aligner (and defined by the signal(s)). The patient's teeth are repositioned/re-orientated from their initial tooth arrangement to a final, prescribed tooth arrangement by virtue of the various incremental aligners being (removably) worn (at least intermittently) over a prescribed time period by the patient. After each incremental aligner is worn by the patient, and the patient's teeth are repositioned/re-orientated accordingly, then the next incremental aligner can be worn by the patient to achieve the next incremental repositioning/re-orientation. Thus, as can be understood in view of the foregoing, in a non-limiting example embodiment herein, at least one or more of the incremental aligners has a construction such that, when worn by the patient, lower arch teeth alignment of the patient's teeth is performed in accordance with step 216 of FIG. 2, at least one or more of the incremental aligners has a construction such that, when worn by the patient, upper arch teeth alignment of the patient's teeth is performed in accordance with step 316 of FIG. 2, and/or at least one or more of the incremental aligners is constructed such that, when worn by the patient, final articulation of the patient's teeth is performed in accordance with step 110 of FIG. 1. In some example embodiments herein, at least one or more of the incremental aligners has a construction such that, when worn by the patient, at least one of lower arch teeth alignment, upper arch teeth alignment, or final teeth alignment, of the patient's teeth, is performed by the aligner(s) in accordance with steps 216, 316, and 110, respectively, of FIG. 1. Patient wear is performed until each of the aligners has been worn by the patient and the teeth are deemed to be placed in the final arrangement and to achieve optimal alignment. According to an example aspect herein, the process also is performed without requiring use of traditional metal braces, TADs, Class II connectors, headgear, elastics, wires and the like, as were required to reposition a patient's teeth in the prior art. Also according to an example embodiment herein, the process can be performed to overcorrect for an overbite, overjet, leveling curve of Spee/Wilson, rotations, proclinations of teeth, or the like. In other words, the geometry of the aligner(s) may be such that one or more teeth can be moved beyond a final tooth arrangement, to compensate for possible relapse and/or help speed up rate of correction, as determined during the stagings 106-110.

It should be noted that, as represented by the dashed lines in FIG. 1, at least part of one or more of the steps 104-110 (and 112) can be performed over again in the process of aligning the teeth of the 3D model. By example only, it may be determined during performance of any of the steps 106-110 (and 112) that at least part of one or more of the earlier-performed steps should be performed again to re-adjust the teeth according to the respective earlier step(s). Then the step(s) can be performed again to the extent deemed suitable, and the method continues as described above.

As described above, preferably the various types of stagings described above are performed to avoid or substantially minimize mesial/distal contact collisions, because movement of teeth with (plastic) aligners can require it, in at least some cases, given that tooth enamel cannot be forced/moved through tooth enamel (whether considering a singular tooth or plural teeth). Also, as described above, various types of considerations can be made, and various types of procedures and functions can be performed, in steps 216 and 316. By example and without limitation, one or more of steps 216 and 316 can involve individual/sequential distalization or step distalization, to enable correction of sagittal (anterior/posterior) malocclusions, without requiring use of elastics/headgear and other mechanisms typically required in the prior art, and while relieving crowding in lieu of collateral/unwanted protrusive movements of anterior teeth. Staging in steps 216 and/or 316 also can include automated (e.g., artificial intelligent) and/or manual movement of teeth to a prescribed curve of Spee and/or Wilson in a flexible grid with, by example and without limitation, 1 mm, 5 mm, or 10 mm increments. Bite Ramps (anterior/posterior) also can be employed (at least in step 316) to mitigate deep bites (anterior) or open bites (posterior).

Also according to an example embodiment herein, staging according to step 110 can include, by example and without limitation, an automatic or manual alignment of a best fit of final staging orthodontic occlusion to augment function/stability/retention of (e.g., clear) aligner treatment. Such staging also can include overcorrection of an overbite, overjet, leveling curve of Spee/Wilson, rotations, proclinations of teeth, or the like.

Also according to one example embodiment herein, a template can be employed and included in the 3D space, wherein the template defies the prescribed arch/teeth arrangement. In this embodiment, the above method steps for aligning teeth in a scan (3D model) can be performed/effected by instructing the teeth (and/or arch) in the scan to become positioned in accordance with the arrangement of the template's arch/teeth. In one example embodiment, the instructing is performed by way of a user interface (e.g., user interface 406 and/or 2300 described below). Also in one example embodiment, the instructing is performing by placing the scanned model over the template (or vice versa) in the 3D space, wherein, as a result, the teeth of the model take the arrangement of those of the template.

A treatment procedure according to an example embodiment herein will now be described, with reference to FIGS. 19-38. FIGS. 19-38 depict an interface 2300 that includes various views of a model 1900 including upper and/or lower arches 1902, 1904, and controls 2310 for viewing the model, in a starting step (S) of a treatment plan for aligning teeth. In one example embodiment herein, the model 1900 is obtained as described above in connection with step 102 of FIG. 1.

The interface 1900 generally also includes a forward control 1906, a reverse control 1908, and a play control 1910. Selection of the play control 1910 enables step-wise scrolling through a plurality of steps S-R of the treatment procedure. The interface 1900 and steps S to R are merely illustrative and nature, and are not intended to be limiting or critical to the invention. Indeed, treatment procedure(s) according to example embodiments herein may include more or less than the number of steps S to R represented in FIGS. 19-38. Moreover, no individual step S to R represented in the figure is critical to any previous or subsequent step, and, in other embodiments, procedures that are represented as being performed over multiple steps can be performed in only a single step, in less than the multiple steps, or more than the multiple steps. Likewise, procedures that are represented as being performed in a single step, can be performed in more than the single step, depending on the application of interest.

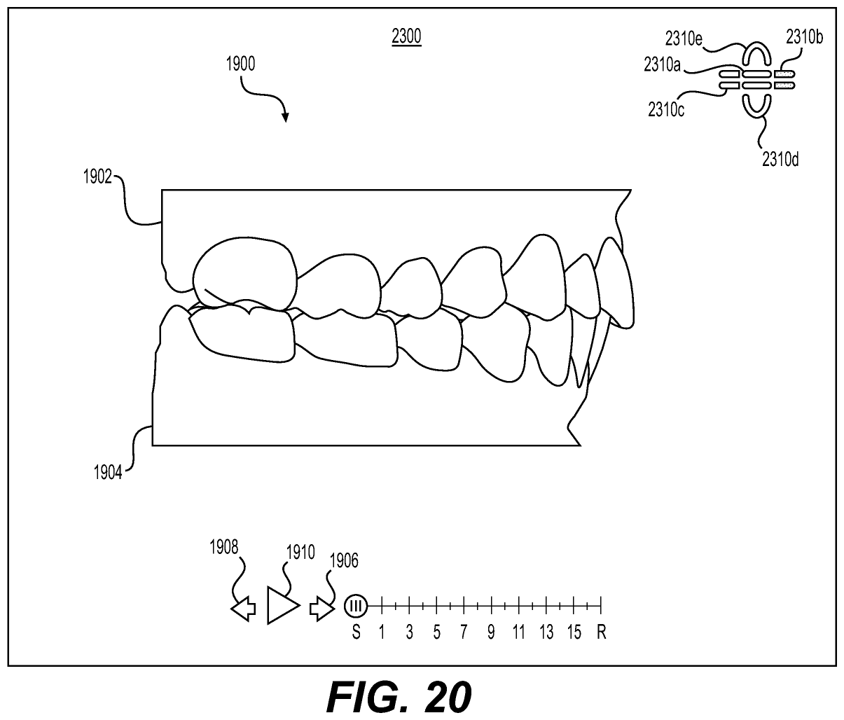

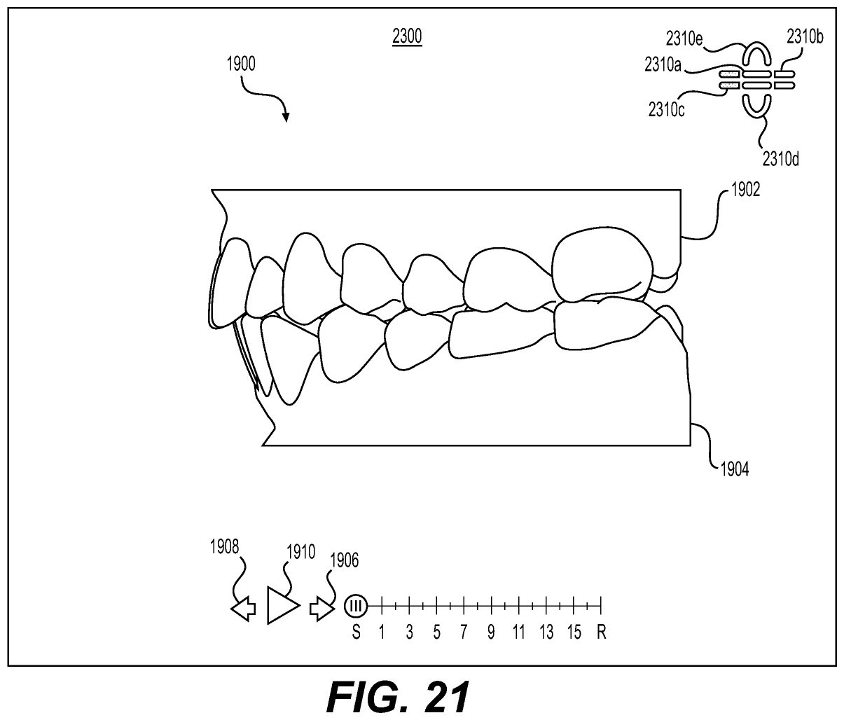

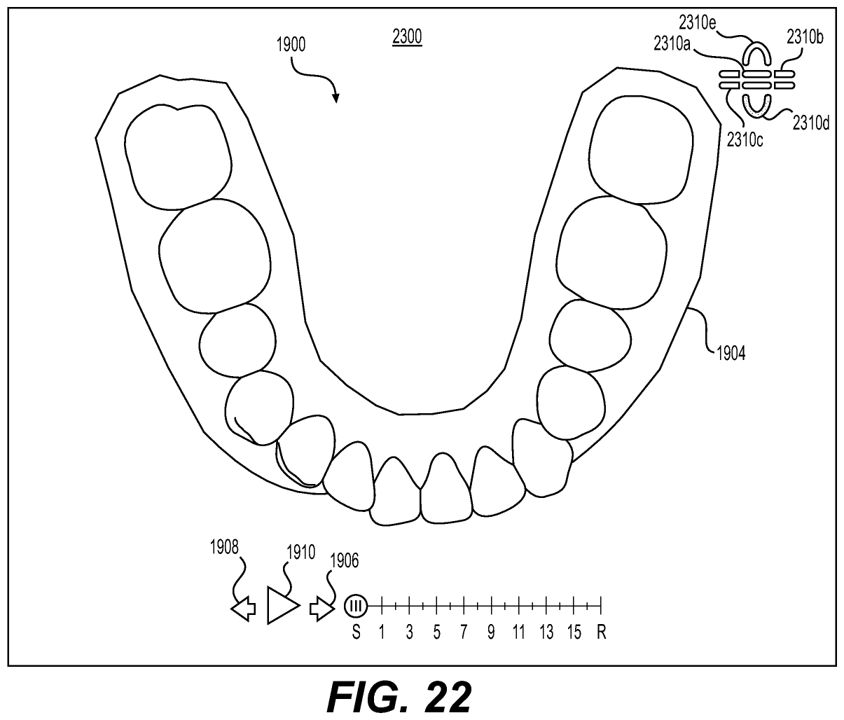

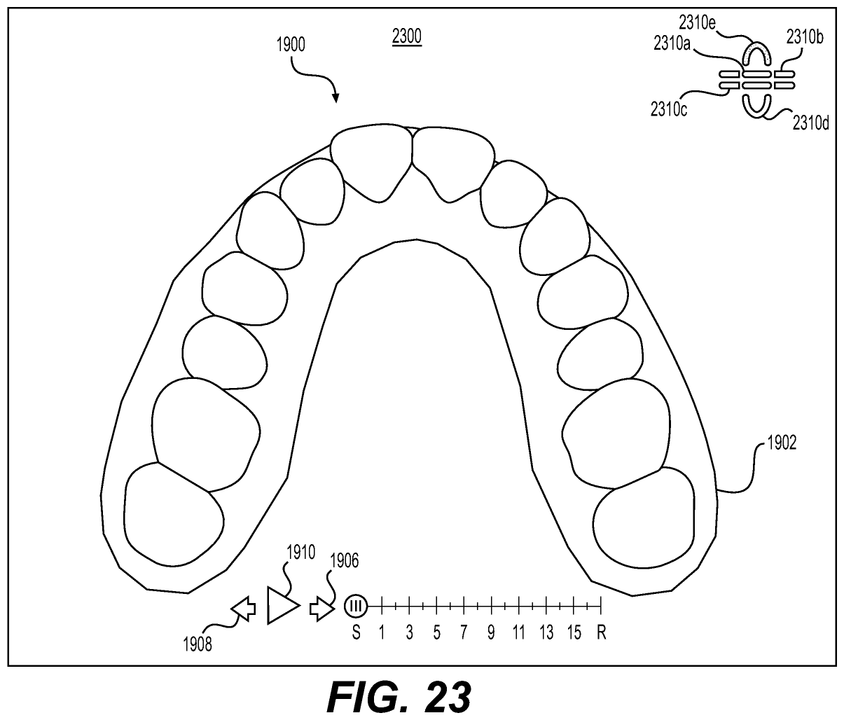

In FIG. 19, control 2310a is shown selected, and, as a result of that selection, the interface 2300 displays a front view of a model 1900 of an upper arch 1902 and lower arch 1904 of a patient, in the starting step (S) of the treatment plan. In FIG. 20, control 2310b is shown selected, and, as a result of that selection, the interface 2300 displays a left side view of the model 1900 of upper and lower arches 1902, 1904. In FIG. 21, control 2310c is shown selected, and, as a result of that selection, the interface 2300 displays a right side view of the model 1900 of the upper and lower arches 1902, 1904. In FIG. 22, control 2310d is shown selected, and, as a result of that selection, the interface 2300 displays the lower arch 1904 of the model 1900. In FIG. 23, control 2310e is shown selected, and, as a result of that selection, the interface 2300 displays the upper arch 1902 of the model 1900.

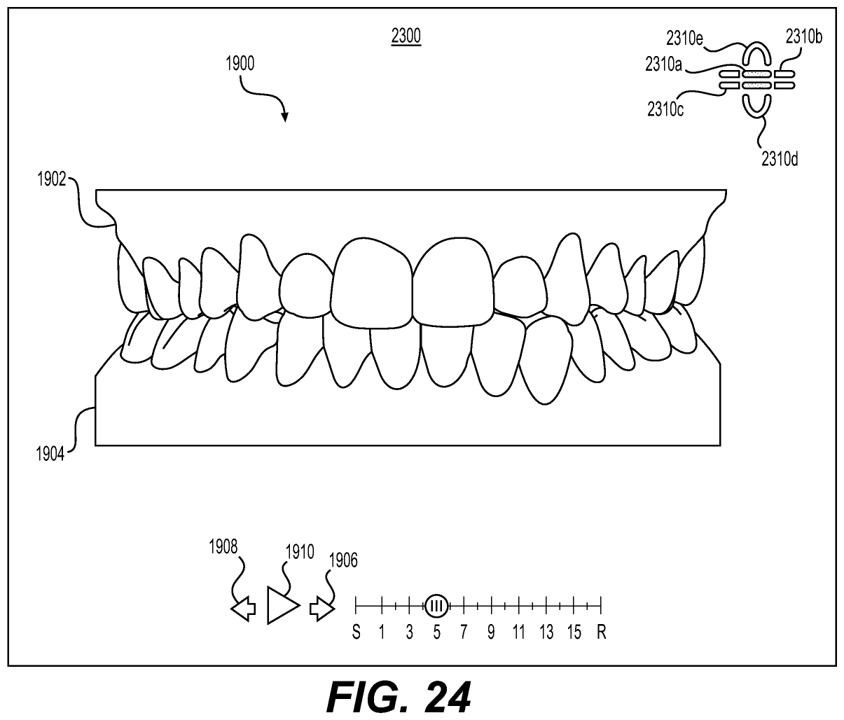

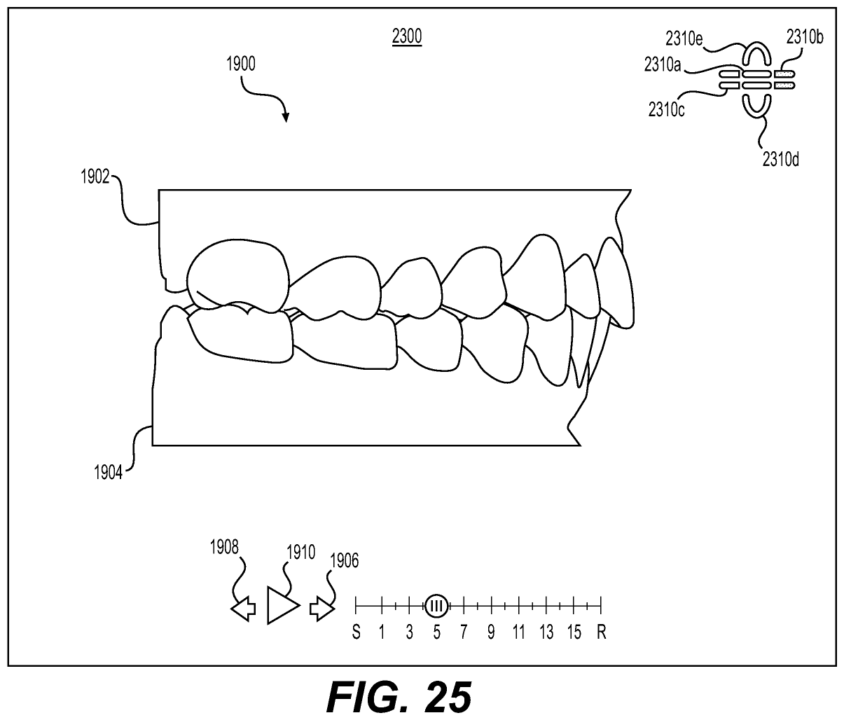

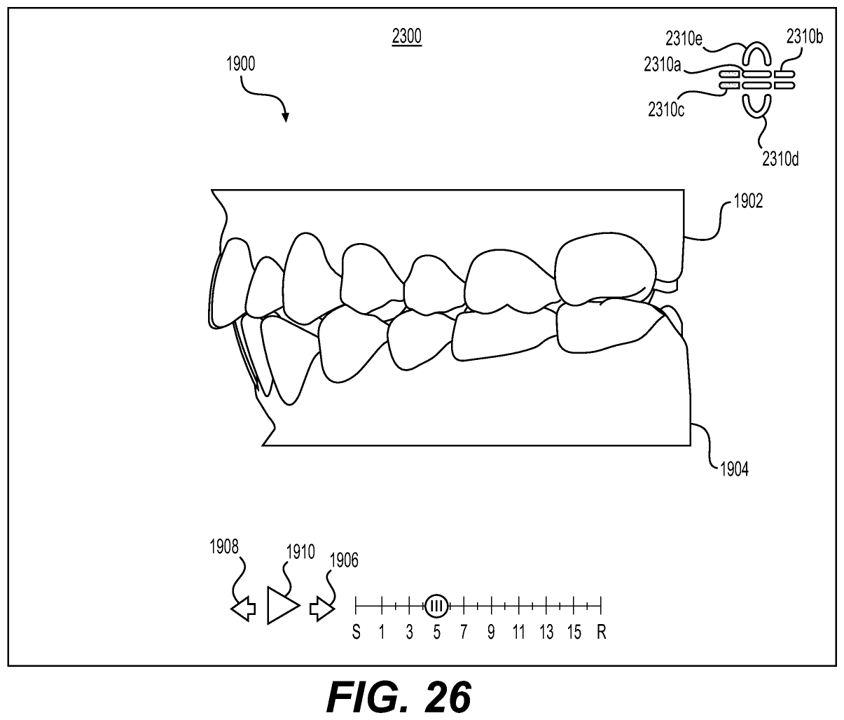

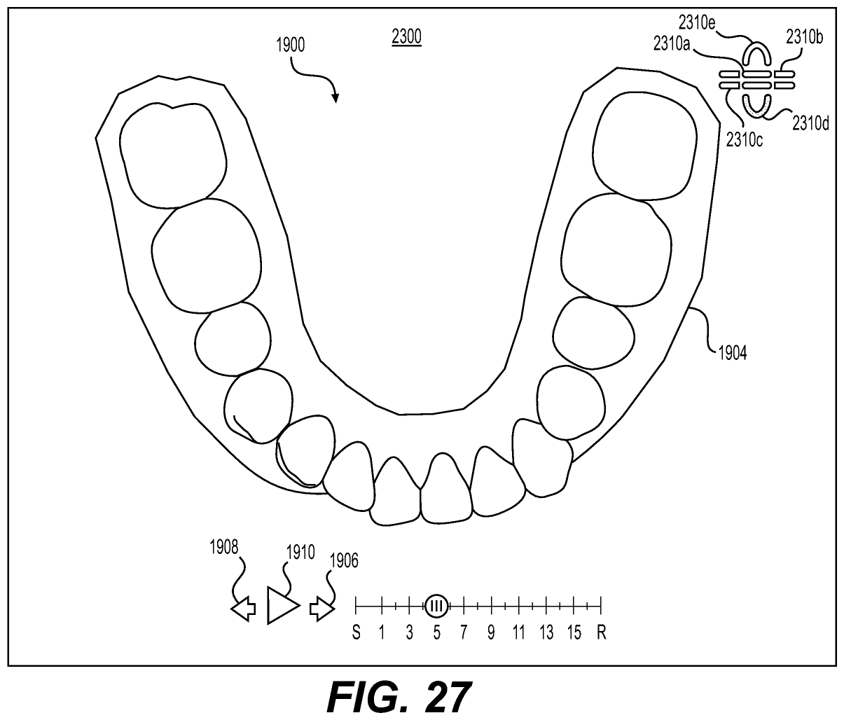

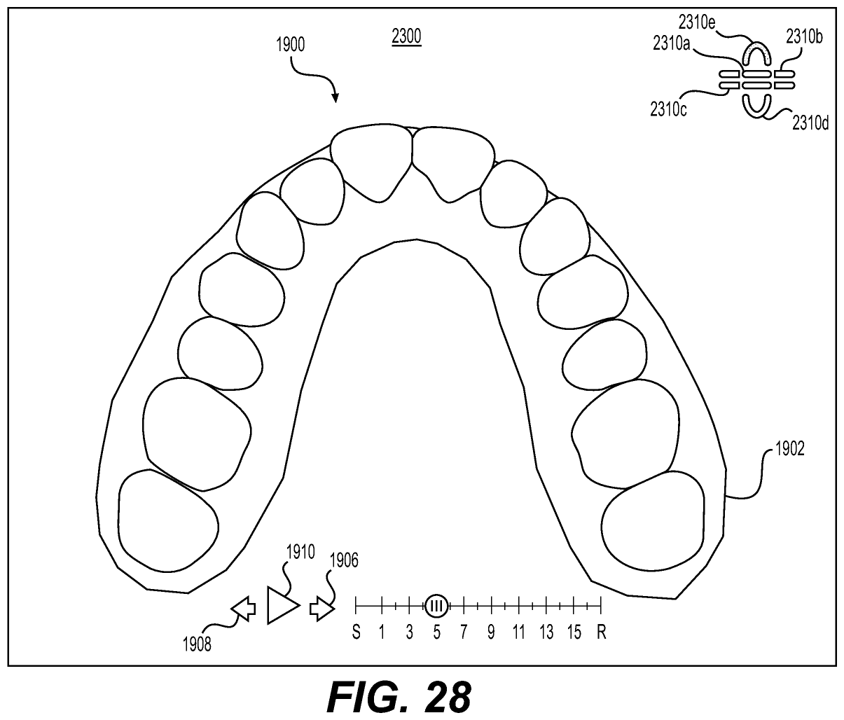

In FIG. 24, control 2310a is shown selected, and, as a result of that selection, the interface 2300 displays a front view of the model 1900 of the upper arch 1902 and lower arch 1904, in a step 5 of the treatment plan. In FIG. 25, control 2310b is shown selected, and, as a result of that selection, the interface 2300 displays a left side view of the model 1900 of upper and lower arches 1902, 1904, in step 5 of the treatment plan. In FIG. 26, control 2310c is shown selected, and, as a result of that selection, the interface 2300 displays a right side view of the model 1900 of the upper and lower arches 1902, 1904, in step 5 of the treatment plan. In FIG. 27, control 2310d is shown selected, and, as a result of that selection, the interface 2300 displays the lower arch 1904 of the model 1900, in step 5 of the treatment plan. In FIG. 28, control 2310e is shown selected, and, as a result of that selection, the interface 2300 displays the upper arch 1902 of the model 1900, in step 5 of the treatment plan.

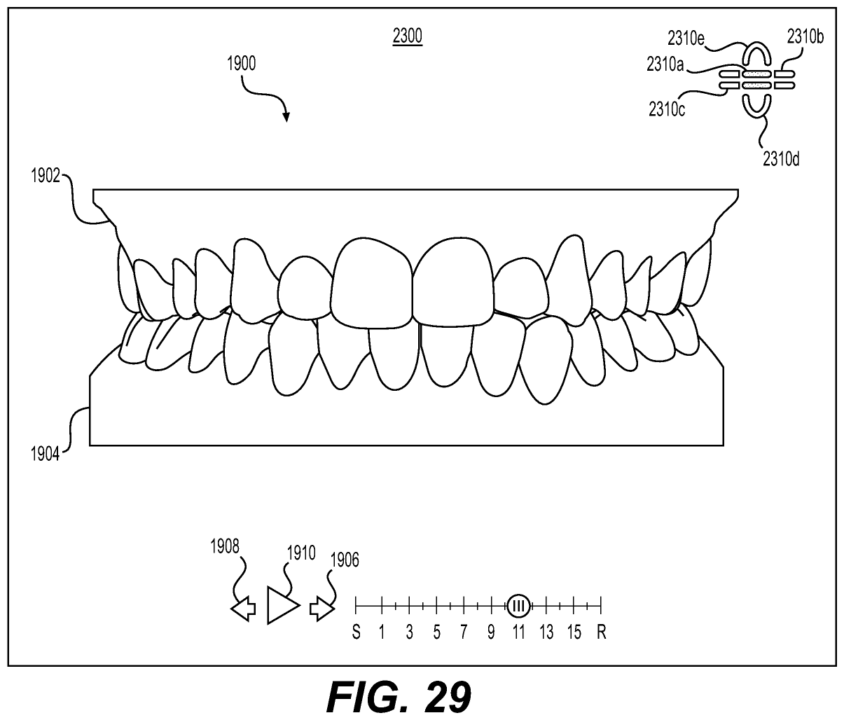

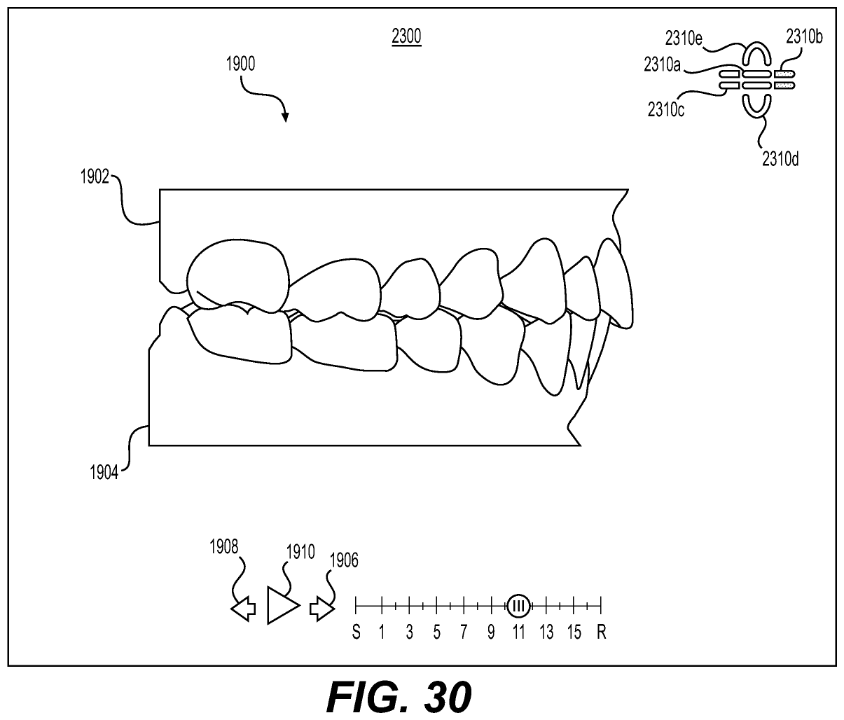

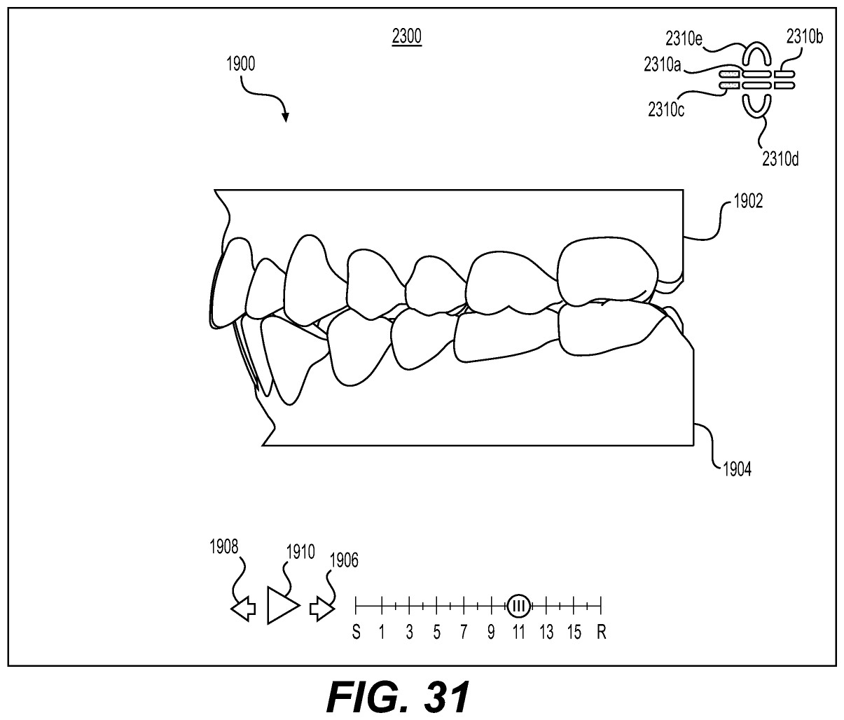

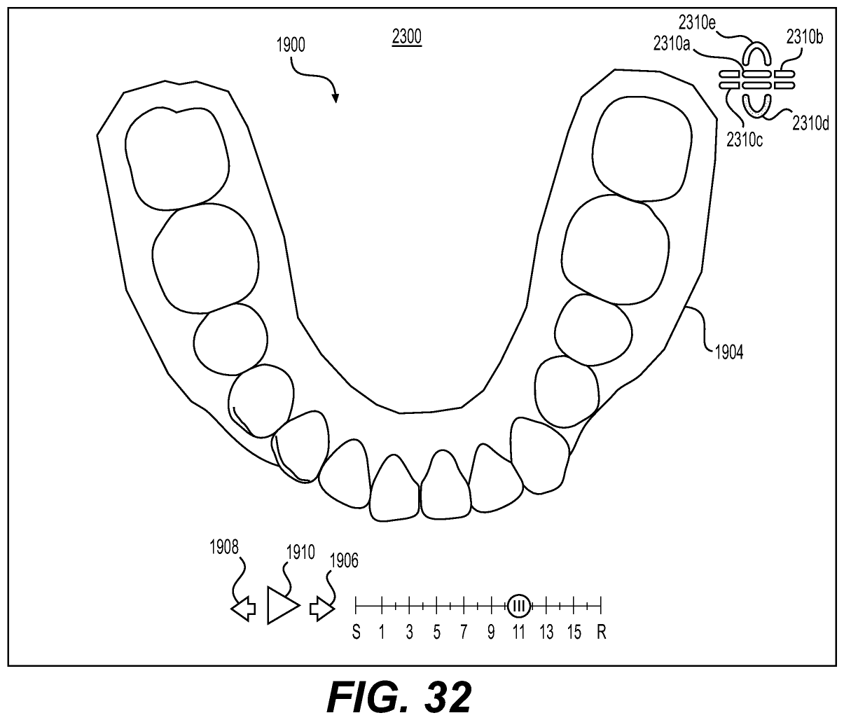

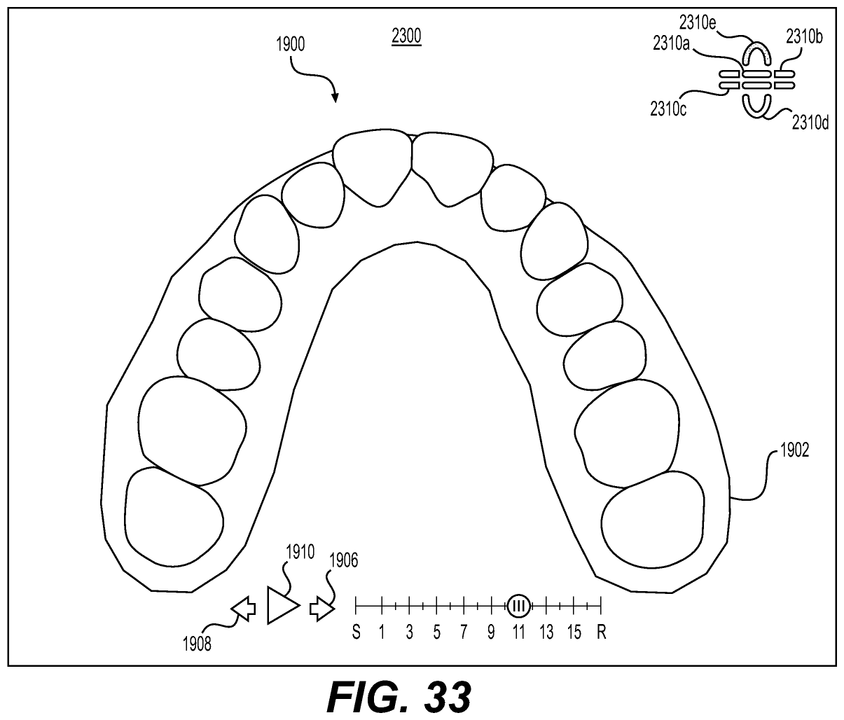

In FIG. 29, control 2310a is shown selected, and, as a result of that selection, the interface 2300 displays a front view of the model 1900 of the upper arch 1902 and lower arch 1904, at a step 11 of the treatment plan. In FIG. 30, control 2310b is shown selected, and, as a result of that selection, the interface 2300 displays a left side view of the model 1900 of upper and lower arches 1902, 1904, at step 11 of the treatment plan. In FIG. 31, control 2310c is shown selected, and, as a result of that selection, the interface 2300 displays a right side view of the model 1900 of the upper and lower arches 1902, 1904, at step 11 of the treatment plan. In FIG. 32, control 2310d is shown selected, and, as a result of that selection, the interface 2300 displays the lower arch 1904 of the model 1900, at step 11 of the treatment plan. In FIG. 33, control 2310e is shown selected, and, as a result of that selection, the interface 2300 displays the upper arch 1902 of the model 1900, at step 11 of the treatment plan.

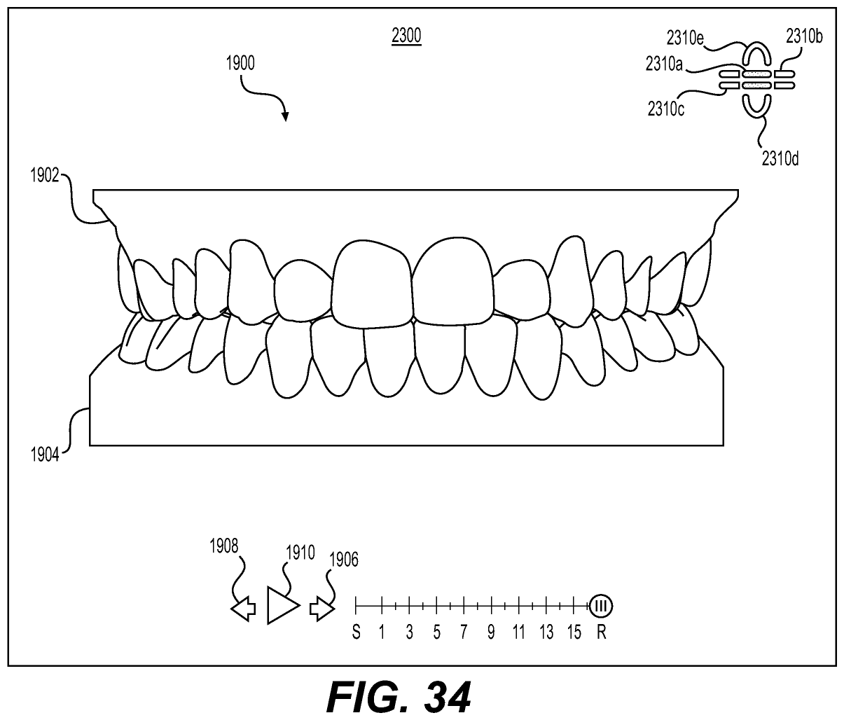

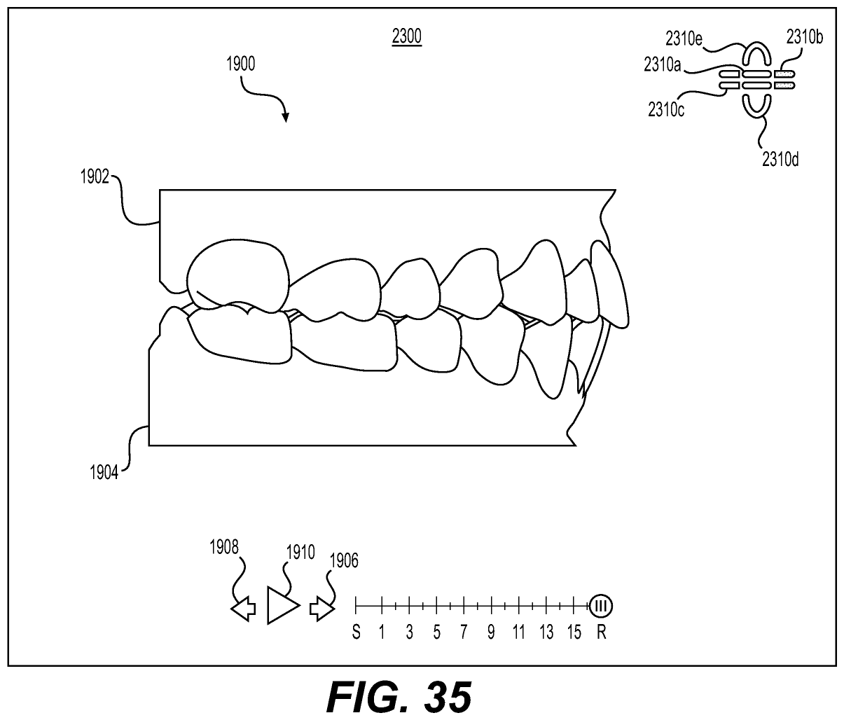

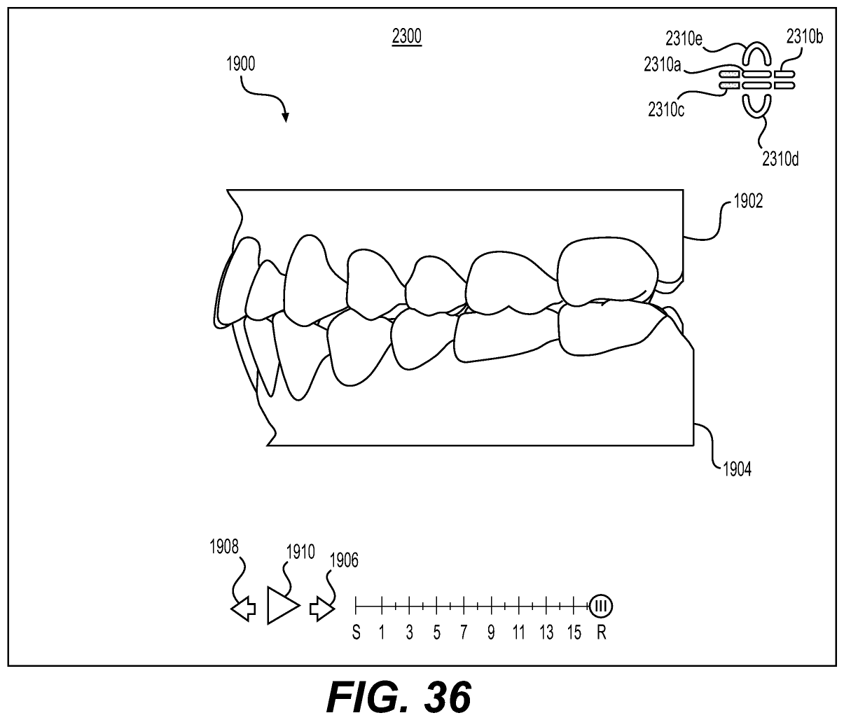

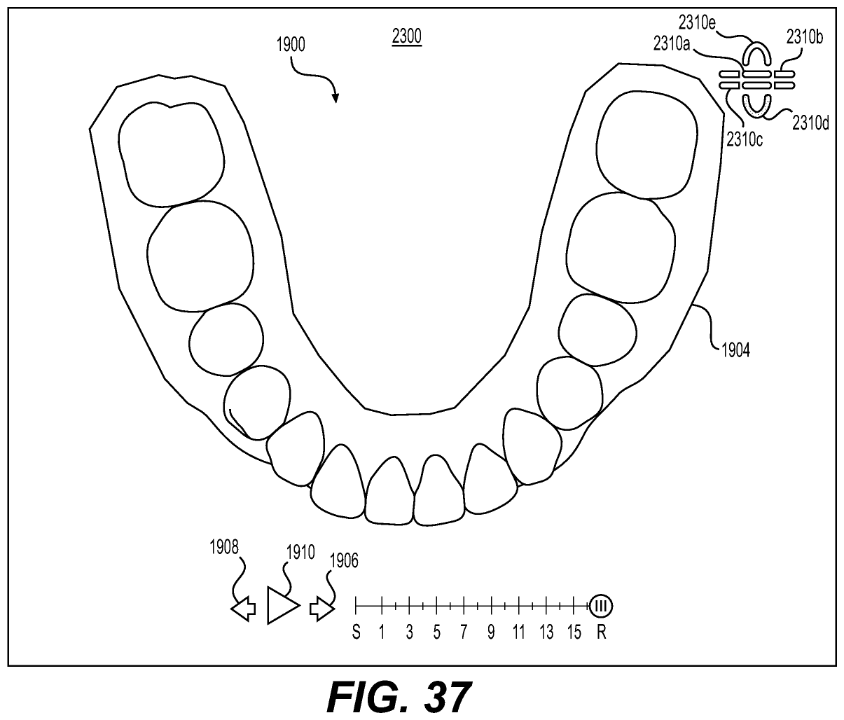

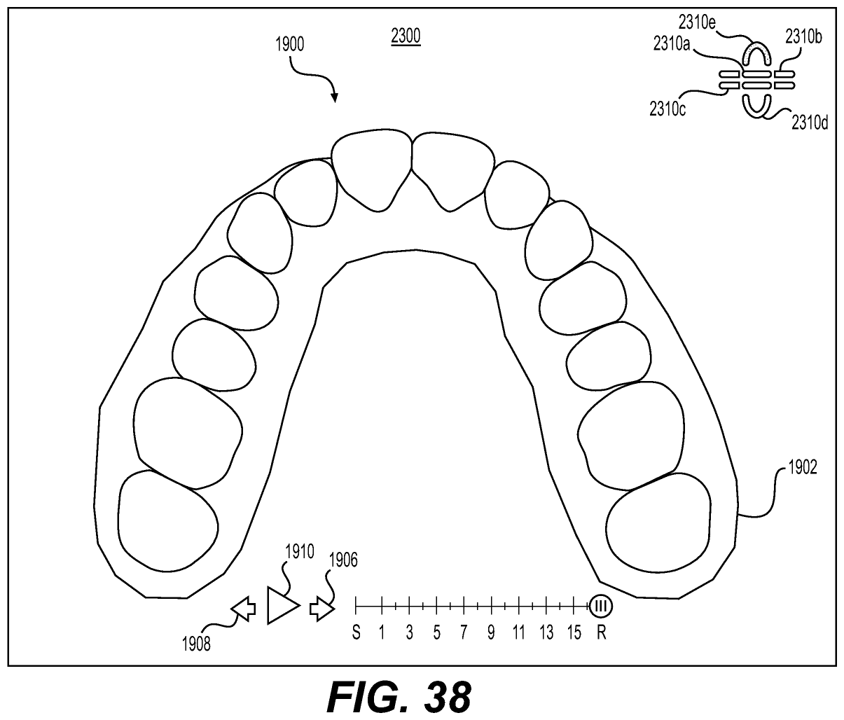

In FIG. 34, control 2310a is shown selected, and, as a result of that selection, the interface 2300 displays a front view of the model 1900 of the upper arch 1902 and lower arch 1904, at a step R of the treatment plan. In FIG. 35, control 2310b is shown selected, and, as a result of that selection, the interface 2300 displays a left side view of the model 1900 of upper and lower arches 1902, 1904, at step R of the treatment plan. In FIG. 36, control 2310c is shown selected, and, as a result of that selection, the interface 2300 displays a right side view of the model 1900 of the upper and lower arches 1902, 1904, at step R of the treatment plan. In FIG. 37, control 2310d is shown selected, and, as a result of that selection, the interface 2300 displays the lower arch 1904 of the model 1900, at step R of the treatment plan. In FIG. 38, control 2310e is shown selected, and, as a result of that selection, the interface 2300 displays the upper arch 1902 of the model 1900, at step R of the treatment plan.

According to one example embodiment herein, treatment according to one or more of FIGS. 19-23 can include one or more of aligning, rotating, and/or buccally expanding teeth, such as, in one example, teeth of at least the lower arch 1904. In some example embodiments herein, one or more of such procedures can be performed in cases in which, by example only, premolars do not have proper alignment and/or mesial/distal rotation. Then, if deemed appropriate, step distalization of the teeth of the lower arch 1904 can be performed to minimize/prevent anterior proclination/protrusion of the lower anterior teeth. By example only, distalization can be performed when the lower anterior periodontal health is deemed compromised, such in cases where there is gingival recession, loss of attached gingiva, and/or thin labial soft tissue/alveolar bone support. In one example embodiment herein, procedures according to the foregoing can be performed in accordance with corresponding parts of step 106 of FIG. 1.

A next part of the treatment according to one or more of FIGS. 19-23 can include fitting teeth of the upper arch 1902 to teeth of the lower arch 1904, while using the lower arch 1904 as a reference/template. In one example embodiment herein, procedures according to this part of the treatment can be performed in accordance with corresponding parts of step 108 of FIG. 1, and can be performed by a user operating the user interface 2300 (e.g., user interface(s) 406) to manipulate one or more teeth of model 1900 to effect the treatment, using a template in the interface or by manipulating such teeth without the template.

In one example embodiment herein, the fitting includes no more than a predetermined number of steps (e.g., sixteen steps, twenty steps, or another predetermined number of steps), and the treatment includes no more than a predetermined number of steps per arch (e.g., twelve steps, sixteen steps, or another predetermined number of steps per arch), although in other example embodiments, the procedure can include any other number of steps and any number of steps per arch, as deemed appropriate to achieve desired teeth alignment. Preferably, it is confirmed that there are no mesial/distal tooth contact collisions during stagings of all tooth movements. Also in one example embodiment herein, the treatment procedure involves no attachments, no IPRs, and no extractions, although in some embodiments, they can be included. By example only, in some embodiments, extractions can be performed for molars (e.g., third molars) and lower incisor(s).

Also in one example embodiment herein, the treatment according to one or more of FIGS. 19-23 involves tooth movement velocities based on 14 day wear of a dental aligner, for 22 hours per day per step. In one example embodiment herein, a maximum tooth movement velocity is about 0.3 mm, or 3° per step. These examples are not exclusive. The treatment according to one or more of FIGS. 19-23 can include continuously confirming that maximum intrusive tooth movement is not greater than 1 mm per tooth, and, in one example embodiment herein, extrusive tooth movement is not greater than 0.5 mm per tooth (or, 0.1 mm per step, in some cases), with velocity of tooth movement distributed over as many steps as possible. Maximum step distalization tooth movement velocities, in one example embodiment herein, mirror maximum tooth movement velocities of 0.3 mm, or 3° per step.

In one example embodiment herein, there can be a limit on the number of simultaneous tooth movements that are performed, for example, in a particular treatment step. By example only, a maximum number of simultaneous tooth movements can be six or seven teeth per step, although in other example, another maximum number or no maximum number can be employed.

In addition, according to an example embodiment herein, both the upper and lower arches 1902, 1904 of the patient can be treated in the treatment according to one or more of FIGS. 19-23, even if only a single one of the arches 1902, 1904 is directed to be treated by prescription. However, in other embodiments, both arches 1902, 1904 do not need to be treated in the treatment plan. Preferably, the treatment involves confirming that there are no mesial/distal tooth contact collisions in staging movements.

According to one example embodiment herein, treatment according to one or more of FIGS. 24-38 can include confirming broad SYMMETRICAL Arch Forms, and/or can be performed according to corresponding parts of step 110 of FIG. 1. If x-bite or a constricted arch form is detected, then the lower arch 1904 can be expanded (e.g., via coronal buccal tipping movements) and the upper arch 1902 form can be over expanded (e.g., via buccal translation/bodily movements). As an illustrative example only, molar movements of 1.5 mm can be performed, premolar movements of 1.0 mm can be performed, and canine movements of 0.5 mm can be performed, beyond ideal on each side, although in practice there is seldom a need to over expand teeth of the lower arch.

Also in one example embodiment herein, unilateral expansion preferably is avoided, and/or only performed where deemed necessary, with attention paid to a broad symmetrical arch form, although this example is not limiting.

Also in one example embodiment herein, step distalization (primarily)/step mesialization (which, for some patients, is rarely performed), when performed, is done so to avoid any in mass (e.g., 1 or more teeth) tooth movements. Step distalization, in one example embodiment herein, can occur in increments of 0.3 mm or 0.6 mm. If third molars are marked as removed (e.g., in a supporting document), step distalization can be performed for molars, as required on a case-by-case basis. Step distalization can be difficult in quadrants where third molars are present (e.g., where they are impacted/partially impacted/erupted). As such, if third molars are marked as not removed (e.g., in a supporting document) or present in the scan/models, step distalization can be limited to a predetermined maximum (e.g., 1 mm).

In one example embodiment herein, unilateral step preferably distalization is avoided, with attention paid to the upper/lower dental midlines (and only if deemed necessary), although this example is not limiting.

Also, during treatment according to one or more of FIGS. 24-38, non-contact/uncoupled anterior occlusion preferably is confirmed/performed. In one example embodiment herein, this can be performed by or based on (i) palatal root/labial crown torque to upper incisors, (ii) more acute inter-incisal angle (when teeth are too upright), and/or (iii) distal root/mesial crown angulation, all to provide some space between the lingual of the upper incisors and incisal edge or facial of the lower incisors. Thus, preferably anterior occlusion can be uncoupled to prevent posterior open bites following clear aligner treatment.

According to an example embodiment herein, during treatment according to one or more of FIGS. 24-38, it is confirmed that there is no IPR/No Spaces. In one example embodiment herein, in lieu of spacing in one arch and/or IPR in the other arch, the crown torque on the upper and lower anterior teeth can be changed, preferably enough to close spaces in one arch and avoid IPR in the opposite arch. Often, there is an anterior inclination (torque) problem to address, rather than a Bolton Discrepancy. Palatal root/buccal crown torque and/or distal root/mesial crown angulation of the upper anterior teeth can be performed.

Also during treatment according to one or more of FIGS. 24-38, Aesthetic/Artistic positioning of the upper/lower anterior teeth preferably is confirmed such as via distal root/mesial crown angulation, although this example is non-limiting. In one example embodiment herein, upper anterior bite ramps can be employed for patients with deep bites, U2-2 or U3's depending on malocclusion.

In one example embodiment herein, to not close all spaces is allowed during treatment according to one or more of FIGS. 24-38, but only if there is an existing extraction space present, or a specific directive from a treating orthodontist. In another example embodiment herein, all or at least some spaces are closed unless there is an existing extraction space present, or a specific directive from the treating orthodontist. Of course, these examples are non-limiting, and, in other examples there may be variations therefrom.

Also in one example embodiment herein, as a last option to closing spaces, a negative smile line can be created. A bridge can be moved transversely as a single unit if identified or mentioned in a medical form or medical/dental history (e.g., x-rays), and deemed necessary.

In one example embodiment herein, during treatment according to one or more of FIGS. 24-38, at the treating orthodontist's discretion, cases can be processed with retained deciduous/primary teeth, but these teeth preferably cannot be moved.

Also, preferably during such treatment, lower incisors are not moved forward from their intended final position(s) (e.g., round tripping), in order to avoid or substantially minimize occlusal interferences, mobility, trauma, etc., although this example is not limiting. Preferably, Posttreatment Overjet should not be made worse than the Pretreatment Overjet, although this example also is not limiting.

In the foregoing manner according to the treatment of FIGS. 19-38, the position, orientation, and alignment of the teeth of the model 1900 can be optimized in terms of function and aesthetics and the teeth can be placed in a prescribed final arrangement. Thereafter, one or more dental aligners can be generated/manufactured that have structures that enable the patient's teeth to be incrementally repositioned and/or re-orientated in a manner as planned for/determined according to FIGS. 19-38 (e.g., and steps 106-110) such that the patient's teeth can be optimally aligned in terms of function and aesthetics, and placed in the prescribed final arrangement. In one example embodiment, the dental aligners are generated/manufactured as described above in connection with step 112 of FIG. 1, and have a construction as represented in FIG. 6, although these examples are not limiting.

In example embodiments herein, the dental aligners have geometries that, when each respective aligner is worn for a respective prescribed/predetermined amount of time by the patient, one or more respective teeth are repositioned/re-orientated over the time period in the manner defined by the aligner geometry and the corresponding signal(s). By virtue of the patient wearing the aligners on his/her teeth, one or more teeth undergo a cumulative translation after being moved cumulatively by the incrementally-worn aligners.

In one example embodiment herein, each aligner (a representation of one of which is shown in FIG. 6) generated/manufactured as described above has tooth receiving cavity 602 having geometry 604 corresponding to an intermediate or final tooth arrangement intended for the aligner (and defined by the signal(s)). As but one illustrative example, each respective aligner has a corresponding cavity 602 and geometry 604 corresponding to a respective one of the steps S-R represented in FIGS. 19-38. As but one illustrative example and without limitation, after an aligner having a cavity 602 and geometry 604 corresponding to step 5 is manufactured and then worn by the patient over a prescribed period of time, the patient's teeth are repositioned/re-orientated from their pre-existing tooth arrangement to a tooth arrangement specified by step 5 (e.g., an arrangement arrived at in step 5, after the procedures for that step have been performed). Similarly, after an aligner having a cavity 602 and geometry 604 corresponding to step 11 is manufactured and then worn by the patient over a prescribed period of time, the patient's teeth are repositioned/re-orientated from their pre-existing tooth arrangement to a tooth arrangement specified by step 11 (e.g., an arrangement arrived at in step 11, after the procedures for that step have been performed). After each incremental aligner is worn by the patient, and the patient's teeth are repositioned/re-orientated accordingly, then the next incremental aligner (corresponding to a particular step S-R) can be worn by the patient to achieve the next incremental repositioning/re-orientation. This process is performed until each of the aligners has been worn by the patient and the teeth are deemed to be placed in the final arrangement and to achieve optimal alignment. In one non-limiting example embodiment herein, the final arrangement is in accordance with the tooth arrangement specified by step R (e.g., an arrangement arrived at in step R, after the procedures for that step have been performed) (in one example embodiment, “R” represents “ready for aligners”).

In one non-limiting example embodiment herein, each aligner preferably is worn by the patient for about 14 days, for 22 hours per day, and a maximum tooth movement velocity effected by each aligner is about 0.3 mm, or 3°, although in other examples, other prescriptions may be employed instead.

According to an example aspect herein, wearing of the aligners by the patient is performed without requiring use of traditional metal braces, TADs, Class II connectors, headgear, elastics, wires and the like, as were required to reposition a patient's teeth in the prior art. Also according to an example embodiment herein, the process can be performed to overcorrect for an overbite, overjet, leveling curve of Spee/Wilson, rotations, proclinations of teeth, or the like. In other words, the geometry of the aligner(s) may be such that one or more teeth can be moved beyond a final tooth arrangement, to compensate for possible relapse and/or help speed up rate of correction (e.g., as determined during the stagings 106-110).

According to an example embodiment herein, software and/or interfaces herein can have a capability of performing one or more of superimposition, measurement of grid-horizontal/vertical bold lines (e.g., having a predetermined spacing, such as, without limitation, every 10 mm), inclusion of attachments (e.g., Bite Ramps), Occlusal Contact Collision Detection (e.g., in each step), Mesial/Distal Contact Collision Detection (e.g., in each step), and a 5-View Composite. Also according to an example embodiment herein, software and/or interfaces herein can have a capability of providing one or more of a Tooth Movement Assessment and/or an Icon Summary of tooth movements (e.g., in each step), a Tooth Movements Table, such as one including a Numeric Summary of tooth movements (e.g., for each step), a Bolton Analysis, OverJet/OverBite measurements (e.g., from initial to final), Arch Width-U/L (e.g., 3/4/5/6/7's), and Dynamic Virtual Pontics. Also according to an example embodiment herein, software and/or interfaces herein can have one or more of a capability of setting Occlusal Plane(s) (e.g., Horizontal/Vertical), and performing Tooth Numbering (e.g., Palmer notation, Universal notation, International notation), passive eruption for cases (e.g., for children, adolescents, and at least some adults) where the teeth may need to passively erupt rather than be trapped in a static position). Also according to an example embodiment herein, software and/or interfaces herein can have one or more of a capability of exporting information, setting up information, recording movies and screenshots, STL file(s), and the like. Also according to an example embodiment herein, software and/or interfaces herein can provide one or more of attachments (e.g., button attachments, bite ramps, precision cuts, and/or other dental attachments), IPRs, and locations and amounts thereof.

A further example aspect herein will now be described. According to this example aspect, a computer-implemented intelligent method, system, and computer-readable medium are provided that collect and employ pre-treatment, in-treatment, and post-treatment information for optimizing orthodontic treatment plans and tooth movements. In one example embodiment herein, the optimization is based on one or more previously performed treatments for patients, and artificial intelligence involving a learning algorithm can be employed to effect optimization of treatment plans.

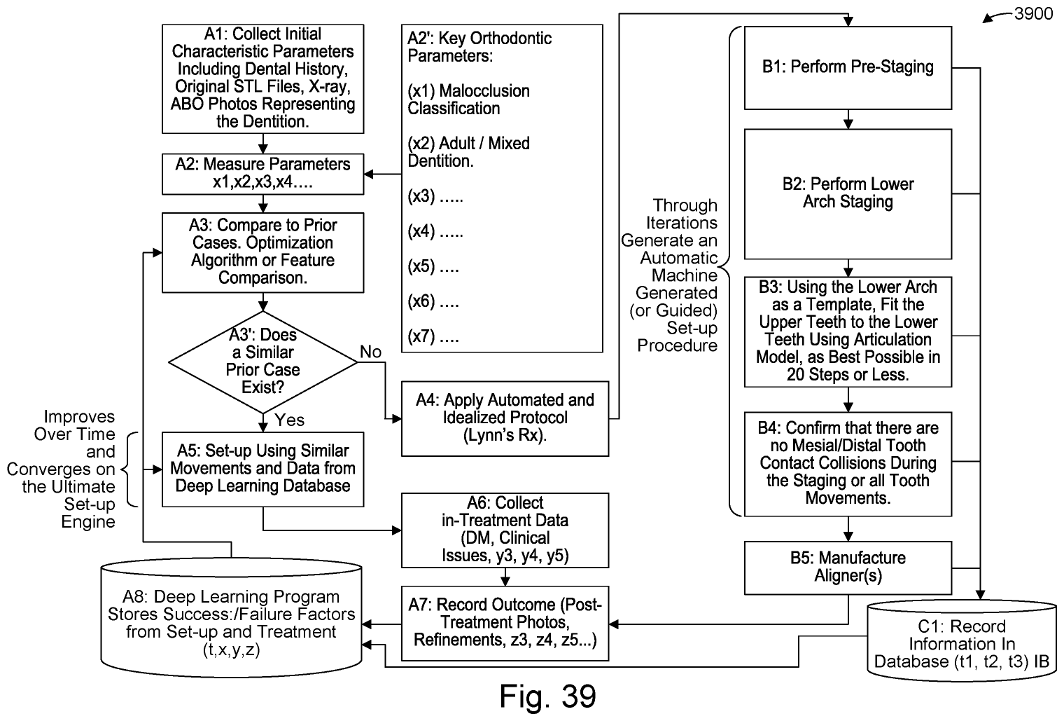

Reference is now made to FIG. 39, which depicts a flow diagram of a method 3900 according to the present example embodiment. At step A1, various types of information relating to a patient is obtained. In one non-limiting example embodiment herein, step A1 includes obtaining a patient's (e.g., “patient P1”) demographic information, dental x-rays, and/or digital and/or physical intra-oral impression data. In addition to or in lieu thereof, step A1 also can include obtaining clinical detail information about the patient, such as information specifying whether the patient has adult or mixed dentition, periodontal disease, the patient's medical/dental history, and skeletal anomalies, and information defining such parameter(s). Additionally by example, information obtained in step A1 also can include, without limitation, diagnostic stereolithography representations of any such dentition(s), dental x-ray data, and photographs, photographic arrays (e.g., an American Board of Orthodontic (ABO) photographs) and the like.

In one example embodiment herein, at least part of step A1 can be performed in the same manner as step 102 described above, although this example is not limiting. By example, in step A1 one or more dental impressions of the patient's dental arches can be obtained. Also in step A1, one or more positive reproductions (i.e., a cast or model) then can be formed of the dental arches, including a reproduction of the teeth and soft tissue. Additionally in step A1, 3D scans can be taken (by, for example, scanner 410 of FIG. 4 to be described below) of the reproduction(s) to provide digital data (also referred to herein as “scans” or “3D scans”) representing the reproduction. The 3D scans, which in one example can be included in one or more stereolithography (STL) files, can form a 3D computer model of the upper and lower arches of the patient, and the model can be viewed and manipulated by a user in virtual 3D space via a user interface (such as user-interface 406, e.g., a display, and/or 2300). FIG. 5 shows an example of a displayed 3D model of a patient's lower arch. (FIG. 19 represents an example interface 2300 that shows a computer model 1900 (e.g., 2D or 3D) of an upper and lower arch at a starting step S of a treatment procedure, as described above). In another example embodiment, the positive reproduction need not be formed in step A1, and instead (using, e.g., scanner 410) a direct digital impression of the patient's arch can be obtained in step A1 or the physical dental impression is digitized for being employed in the steps below.

Before describing step A2, indices for assessing orthodontic conditions of a patient will first be described. It is well known that the length and success of an orthodontic treatment can be related, at least in part, to initial orthodontic conditions (and/or a severity thereof) present in the patient, as determined based on one or more orthodontic/dental indices (hereinafter referred to as “dental indices” for convenience). Dental indices enable the measuring, grading, scoring, assessing, and analyzing of dental conditions (e.g., malocclusions) in individuals and groups. A dental index defines the status of individuals or groups with respect to the applicable condition(s) being measured. There are many types of dental indices. Dental indices can measure the presence or absence of a condition, or they can be cumulative, measuring all past and present evidence of a condition. Irreversible indices measure conditions that will not change, such as dental caries. A reversible index measures conditions that can be changed, such as the amount of bacterial plaque present. Non-limiting example types of dental indices include Angle's classification, Massler and Frankel's Index, a Malalignment Index, the Occlusal feature index, Handicapping Labiolingual Deviation Index, the Malocclusion Severity Estimate, the Occlusal Index, the Grade Index Scale for Assessment of Treatment Need, the Treatment Priority Index, Little's Irregularity Index, and the like. Angle's classification, for example, describes classes of malocclusion, and is based on a relationship of a mesiobuccal cusp of a maxillary first molar and a buccal groove of a mandibular first molar.

The Massler and Frankel (M and F) index, for example, uses individual teeth as unit of occlusion instead of an arch segment, wherein each tooth is examined to determine whether or not it is in correct occlusion. The total number of maloccluded teeth is then counted and recorded, and each tooth is examined with respect to an occlusal aspect and buccal and labial surfaces excluding third molars. An imperfect occlusion from both occlusal (in perfect alignment with a contact line) and buccal aspects (in perfect alignment with plane of occlusion and in correct interdigitation with opposing teeth) is considered as maloccluded. Each maloccluded tooth is assigned value of ‘1’, and each tooth in perfect occlusion is assigned a score of ‘0’. A score of ‘0’ indicates a perfect occlusion, a score of more than ‘10’ indicates sufficient severity requiring orthodontic treatment, and a score between ‘1’ and ‘9’ indicates normal occlusion not requiring orthodontic treatment.

Other non-limiting examples of dental indices include the Papilla, Marginal gingiva and Attached gingiva (PMA) Index, developed by Schour and Massler (each employ scores from ‘0’ to ‘5’, depending on the severity of inflammation), the Periodontal Screening and Recording (PSR) Index for detection of periodontal disease, the Plaque Index (PI) measured by Silness and Loe, which assesses the thickness of plaque at the cervical margin of a tooth, the Oral Hygiene (OHI) Index developed by Greene, Vermillion, and Waggener, which includes a debris index and a calculus index, the Debris Index, the Calculus Index, Gingival Index (GI) that assesses the severity of gingivitis, the Periodontal Index (PI) that determines periodontal disease status, the Gingival Bleed Status (GBS), the Mobility Index (MI), Dean's Dental Fluorosis Index, the Decayed, Missing and Filled Teeth (DMFT) index, and the like, although these examples are non-exclusive.

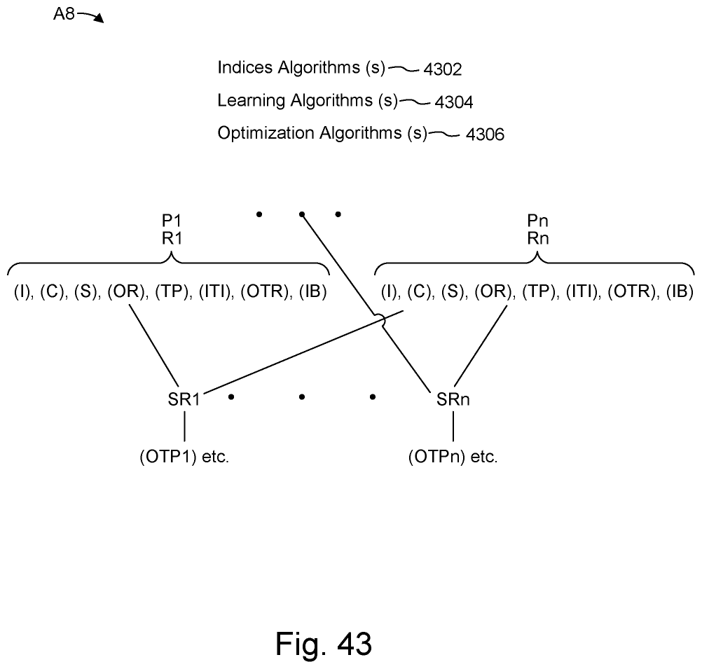

Referring now to step A2, according to an example aspect herein step A2 automatically performs one or more algorithm(s) 4302 (FIG. 43) of one or more predetermined types of dental indices (e.g., automated algorithmic versions of the indices discussed above and/or other predetermined indices), to thereby assess one or more conditions of the patient, using the algorithm(s) 4302, wherein the algorithm(s) 4302 are performed based on content included in the information obtained in step A1. The assessments performed in step A2 can identify the presence (or absence) of particular dental conditions A2′ identifiable by the corresponding indice(s), and/or, in at least some cases, the presence or absence of such conditions can be measured by one or more scores determined in the assessments performed in step A2. By example and without limitation, the dental conditions A2′ may include malocclusion (e.g., a malocclusion classification) (X1), an adult dentition or mixed dentition (X2), and/or any other predetermined type of conditions (X3) to (Xn) identifiable by the indice(s).

In the illustrative example involving use of a Malalignment Index, based on content (e.g., content related to alignment or misalignment of patient P1's teeth) included in the information obtained in step A1, step A2's performance can result in the determination of scores (e.g., ‘0’, ‘1’, ‘2’) representing alignment, minor misalignment, and/or major misalignment of teeth, depending on which of those conditions is indicated in the content of the information obtained in step A1. As another illustrative example where the conditions (X3) to (Xn) include one or more of orthodontic anomalies for crossbite, crowding, spacing, and improper eruption and bite dental malocclusion, skeletal malocclusion, overbite, deep bite, rotations, impacted teeth, periodontal health (e.g., hard tissue-alveolar bone and soft tissue-gingiva, periodontal ligament), dental anomalies, macroglossia, parafunctional habits (e.g., bruxing/clenching), myofunctional habits (e.g., tongue thrusting, lip biting) and airway, the presence or absence of one or more predetermined ones of those conditions can be determined by algorithm(s) 4302 implementing the applicable corresponding types of dental indices for assessing those conditions in step A2 based on the content of the information obtained in step A1.

In one non-limiting illustrative embodiment herein, in step A2 the presence or absence of a crossbite condition can be determined according to the algorithm(s) 4302 implementing indices described in “ABO Discrepancy Index (DI)—A Measure of Case Complexity—American Board of Orthodontics” (2016), available at the following weblink: https://www.americanboardortho.com/media/1189/discrepancy_index_scoring_system.pdf. That publication, which is incorporated by reference herein in its entirety as if set forth fully herein, describes indices providing scoring (e.g., ‘0’ to ‘5’) for an overjet relationship, a negative overjet relationship, an overbite relationship, an interior open bite relationship, a lateral open bite relationship, crowding, an occlusal relationship, a lingual posterior crossbite, a buccal posterior crossbite, cephalometrics, and/or other types of scores relating to a crossbite condition.

It should be noted that each patient evaluation may involve a multitude of possible conditions to be evaluated, and, which types of indices algorithm(s) 4302 are employed in the method 3900 can depend on, for example, the particular application of interest and criteria specified by a treating clinician and/or orthodontist, and/or patient preferences.

Before describing step A3 in detail, database A8 shown in FIG. 39 will first be described, in conjunction with FIG. 43, which shows content included in the database A8 according to an example embodiment herein. In this example embodiment herein, the database A8 stores records R1 to Rn associated with respective identifiers of patients P1 to Pn. By example and without limitation, the records R1 to Rn include, with respect to each patient (P1 to Pn), information (I) obtained for the patient in a previous performance of step A1 for that patient, conditions (C) and scores (S) determined for the patient in previous performances of step A2 for the patient, other records (OR) (e.g., R1 to Rn, SR1 to SRn) correlated to in previous performances of steps A3 and A3′ (to be described below) for the patient, treatment plans (TP) determined (and/or performed) for the patient in previous performances of step A5 and/or B1 to B5 (to be described below) for the patient, in-treatment information (ITI) obtained for the patient in a previous performance of step A6 (to be described below), outcome records (OTR) obtained for the patient in a previous performance of step A7, and information (IB) that may have been obtained for the patient in previous performances of steps B1 to B5 for the patient. Thus, in one example embodiment herein, database A8 stores a record R1 for the present patient P1, based on (and during) the performance of the method 3900 (whether performed in full or in part) of FIG. 39 for that patient P1, and stores records R2 to Rn for prior patients P2 to Pn for whom the method 3900 was performed previously. As can be appreciated in view of this description, the records R1 to Rn include essentially all information determined/obtained during the various steps of the method 3900 of FIG. 39, performed for respective ones of the patients P1 to Pn. For purposes of illustration, the present application is described in the context where the method 3900 was performed previously for patients P2 to Pn, and where present patient P1 is currently under evaluation by the method 3900.

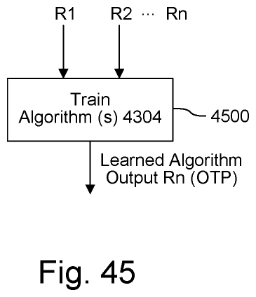

In an example embodiment herein, the database A8 also stores records (referred to herein as “synthesized records SR1 to SRn”) that have been created based on one or more of the records R1 to Rn, using a learning algorithm 4304 such as, by example and without limitation, a deep learning algorithm or a machine learning algorithm according to an example aspect herein. By example and without limitation, the synthesized records SR1 to SRn can be a result of performing a deep learning algorithm (e.g., algorithm 4304) based on one or more predetermined ones of the records R1 to Rn, wherein the deep learning algorithm preferably provides at least one optimum or optimized treatment plan (OTP). Deep learning is a subset of machine learning in which artificial neural networks, involving algorithms inspired by the human brain, learn from large amounts of data. Similar to how humans learn from experience, a deep learning algorithm performs a task repeatedly, each time evolving the process to improve the outcome. In one example embodiment herein, one or more convolution neural networks can be employed to train at least one neural network, and to thereby train the deep learning algorithm (e.g., algorithm 4304, according to step 4500 of FIG. 45 described below), to extract predetermined, useful features, as described herein. Convolution layers detect patterns in data by element-wise multiplications between a slice of input data and weights present within the filter, to identify key driving independent variables. Those variables may vary depending upon the initial patient anomalies and starting conditions, which first can be elucidated from the data by judicious and clinically trained sub-sampling.

As represented in FIG. 45, the algorithm 4304 is trained in a step 4500 using at least some of the records R1 to Rn (and/or existing records SR1 to SRn) to learn optimum treatment plans (OTPs) based on treatment plans (TPs) from the records R1 to Rn (and/or SR1 to SRn), and generate current or new synthesized records SR1 to SRn that include corresponding ones of the optimum treatment plans (OTPs) (e.g., plans (OTP1) to (OTPn)), respectively. During the performance of the method 3900 of FIG. 39, information of the records R1 of the present patient P1 can be input to step 4500 from step A7 of FIG. 39, or from database C1 (including information (IB)) of FIG. 39, to be described below, to cause the algorithm(s) 4304 to learn an optimum treatment plan (OTP1) for the patient P1. In some cases, the optimum treatment plan (OTP) may be based only on records R1 to Rn resulting from the performance of step A5 for the patients P1 to Pn, in other cases the optimum treatment plan (OTP) may be based only on records R1 to Rn resulting from the performance of steps B1 to B5 (described below) for the patients P1 to Pn, and in still other cases the optimum treatment plan (OTP) may be based on a combination of both, depending on which sources are used to train the algorithm(s) 4304 and applicable operating criteria. Also, in some example embodiments herein, all or only predetermined ones of the records R1 to R2 can be employed in step 4500 to train the algorithm 4304. In other example embodiments herein, only those ones of the records R2 to Rn that correlate to, and/or are determined to correlate to, the patient P1 under evaluation (and/or record R1) (e.g., as described below), are employed in step 4500 to train the algorithm 4304. By example, in one example embodiment herein, only the best record (BR) identified in step 4418 to be described below, is employed either alone or in conjunction with the present patient P1's record (R1), in step 4500 to train the algorithm 4304 in step 4500. In still other embodiments herein, one or more records R2 to Rn (and/or SR2 to SRn) correlated to in one or more of steps 4402, 4406, 4410, 4414, 4418, 4420, B1, B2, B3, B4, can be employed either alone or in conjunction with the present patient P1's record (R1), in step 4500 to train the algorithm 4304 in step 4500.

In an example embodiment herein, the synthesized records SR1 to SRn are associated in the database A8 with those ones of the records R1 to Rn used by the learning algorithm 4304 to create the synthesized records SR1 to SRn, although the associations represented in FIG. 43 are merely illustrative in nature and not intended to limit to the scope of the invention. Also, in one illustrative example embodiment herein, the treatment plans (TP) of at least some of the records (e.g., R2 to Rn, SR2 to SRn) stored in the database A8 have been deemed to provide a clinically acceptable result based on predetermined clinical criteria (e.g., predetermined success/failure factors (x, y, z)) from set-up and treatment, attained within a predetermined clinically acceptable time frame (e.g., 2 weeks), and/or other criteria (e.g., movement velocity, spacing, etc.) described herein. By example, in one example embodiment herein, treatment plans (TP) are deemed to provide a clinically acceptable result where step 110′ or B4 (each to be described below) was performed successfully for that plan (TP). However, this example is not exclusive. In another example embodiment herein, treatment plans (TP) of one or more records (e.g., R2 to Rn, SR2 to SRn) may be examined (e.g., automatically or by a clinician or orthodontist) before the performance of the method 3900 of FIG. 39 for the present patient P1 being evaluated, or during the performance of step A3 (to be described below) for that patient P1, to determine whether the respective treatment plans (TP) are clinically acceptable (e.g., for present patient P1) based on predetermined criteria (e.g., such as criteria used in step 110′ or B4′ to be described below or other criteria), patient satisfaction, and/or other criteria described herein.

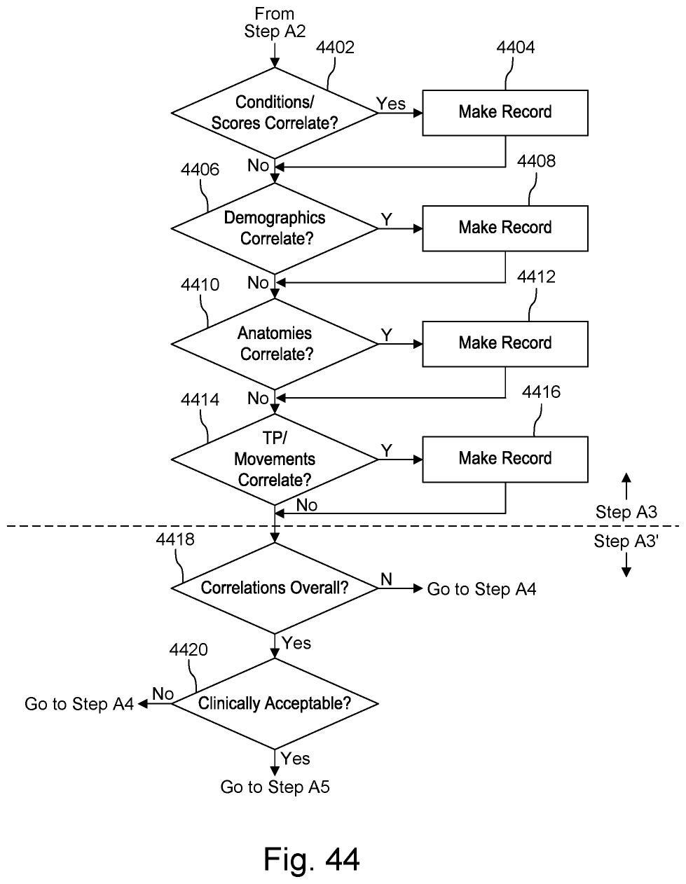

Having described the content of database A8, step A3 of FIG. 39 will now be described. In step A3, a determination is made as to whether one or more predetermined types of information (e.g., (I), (C), (S), (OR), (TP), (ITT), (OTR), (IB)) included in the present patient P1's record R1, correlate to corresponding predetermined type(s) of information (e.g., (I), (C), (S), (OR), (TP), (ITT), (OTR), (IB)) included in the records R2 to Rn, SR2 to SRn, stored in the database A8. In some example embodiments herein, the predetermined types of information include, without limitation, dental conditions, indices scores and assessments and the like, patient demographic information, patient anatomical information, one or more treatment plans, and/or movement(s) of one or more teeth defined in such plans, although in other embodiments herein, other predetermined types of information can be employed as well, or in lieu thereof. Step A3 can include making the foregoing determination with respect to one or more of the predetermined type(s) of information, depending on applicable clinical criteria. In one example embodiment herein, step A3 of FIG. 39 is performed according to steps 4402 to 4416 of FIG. 44, and step A3′ of FIG. 39 (which determines whether there is an overall correlation of patient P1's record R1 with database A8's record(s) providing a clinically acceptable result) is performed according to steps 4418 and 4420 of FIG. 44.

FIG. 44 will now be described, beginning with step 4402 which relates dental conditions (C) and scores (S). In an example embodiment herein, step 4402 can include determining, based on the result (in record R1 of patient P1) of step A2 and at least one or more records R2 to Rn, SR2 to SRn stored in database A8, whether at least some predetermined conditions (C)/scores (S) identified in step A2 for patient P1 correspond to, or are sufficiently similar to, those included in one or more of the records R2 to Rn, SR2 to SRn. More particularly, in one example embodiment herein, in step A3 one or more predetermined conditions (e.g., crossbite, crowding, spacing, bite, improper eruption, etc.) identified for the present patient P1 under evaluation in step A2 are compared to corresponding type(s) of conditions present in records R2 to Rn, SR1 to SRn (stored in database A8) using, in one example embodiment herein, an optimization algorithm 4306 (FIG. 43). In one example embodiment herein, the optimization algorithm 4306 compares predetermined types of conditions (C)/scores (S) of the present patient P1 to corresponding types of conditions (C)/scores (S) present in respective records stored in database A8, in a condition-by-condition basis, a score-by-score basis, and/or an index-by-index basis, in one non-limiting example herein.

As an illustrative example, information regarding a crossbite condition that may have been identified in step A2 (and which is included in record R1 of patient P1) can be compared in step 4402 to information regarding a crossbite condition (if any) from respective records R2 to Rn, SR2 to SRn stored in the database A8 to determine whether the compared information (i.e., the conditions represented by the information) is sufficiently similar, wherein in one example embodiment herein, conditions are deemed sufficiently similar if they are within a predetermined threshold range of one another. In an illustrative example involving a crossbite condition, the comparison of step 4402 may involve comparing scores (S) from record R1 to corresponding scores (S) included in one or more records R2 to Rn, SR2 to SRn stored in database A8, relating to one or more of an overjet relationship, a negative overjet relationship, an overbite relationship, an interior open bite relationship, a lateral open bite relationship, crowding, an occlusal relationship, a lingual posterior crossbite, a buccal posterior crossbite, cephalometrics, and/or other types of scores (S) relating to a crossbite condition.

In an illustrative example involving use of a Malalignment Index, the comparison performed in step 4402 may involve comparing scores (S) (e.g., ‘0’, ‘1’, ‘2’) representing alignment, minor misalignment, and/or major misalignment, respectively, determined in step A2 for record R1 of patient P1, to corresponding types of scores (S) from one or more records R2 to Rn, SR2 to SRn stored in the database A8. If the scores (S) of one or more predetermined ones of such conditions/relationships (e.g., the scores of the overjet relationship of the present patient record R1 and those of at least one of the records R2 to Rn, SR2 to SRn stored in database A8) are within a predetermined corresponding predetermined range of one another, then the conditions (C) of the present patient P1 and those of the applicable record(s) R2 to Rn, SR2 to SRn are deemed sufficiently similar to one another, and thus correlate.

If it is determined in step 4402 that there is a correlation (“Yes” in step 4402), then a record thereof is made (step 4404) with respect to each particular record (R2 to Rn, SR2 to SRn) correlated to, and control passes to step 4406. If it is determined in step 4402 that there is no correlation (“No” in step 4402), then control also passes to step 4406.

Step 4406, relating to demographic information, will now be described. In one example embodiment herein 4406 can include comparing demographic information (e.g., patient age, etc.) obtained in step A1 (as part of record R1) for the present patient P1 to demographic information of patients P2 to Pn from the records R2 to Rn, SR2 to SRn stored in database A8, to determine whether the compared information correlates. In some example embodiments, compared demographic information is deemed to be correlate where the information is the same or sufficiently similar (e.g., within a predetermined range, such as within 5 years in age) to each other. If step 4406 results in a determination that the compared demographic information correlates (“Yes” in step 4406), then a record thereof is made in step 4408 with respect to each record (R2 to Rn, SR2 to SRn) correlated to, after which control passes to step 4410. In a case where the compared demographic information is determined not to correlate (“No” in step 4406), then control passes to step 4410.

In step 4410, other types of orthodontic information (e.g., obtained in step A1) for the present patient P1 is compared to corresponding information included in the records R2 to Rn, SR2 to SRn stored in database A8, such as anatomic information, e.g., tooth/teeth types, jaw types, and/or arch types, and/or shapes, positions, orientations, and/or other predetermined features of such anatomies, to determine whether the compared information correlates, i.e., is the same (e.g., the same tooth type) or sufficiently similar (e.g., within a predetermined range or type of each other), in one example embodiment herein. In a case where the compared information is determined to be the same or sufficiently similar (“Yes” in step 4410), then a record thereof is made in step 4412 with respect to each record (R2 to Rn, SR2 to SRn) correlated to, after which control passes to step 4414. In cases where the compared information is determined not to be the same or sufficiently similar (“No” in step 4410), then the corresponding record(s) stored in database A8 are deemed not correlated with record R1, and control passes to step 4414. In still other example embodiments herein, step 4410 can be performed by comparing anatomic information (e.g., obtained in step A1) for the present patient P1 to anatomic information associated with a predetermined “average” or reference dentition, to determine whether the compared information correlates. In a case where the compared information is determined to be the same or sufficiently similar (“Yes” in step 4410), then a record thereof is made in step 4412 (in association with a predetermined reference record and/or treatment plan associated with the reference dentition), and control passes to step 4414. In cases where the compared information is determined not to be the same or sufficiently similar (“No” in step 4410), then it is determined that there is insufficient correlation, and control passes to step 4414.

Step 4414 will now be described, relating to tooth movements and treatment plans. In one example embodiment herein, step 4414 can include comparing a predetermined type and/or amount of tooth movement (e.g., translation, rotation etc.) for the present patient P1 to a corresponding type and/or amount of tooth movement specified in a treatment plan (TP) of one or more records R2 to Rn, SR2 to SRn stored in database A8, to determine whether the compared type(s)/amount(s) correlate to each other (i.e., are the same or substantially the same). For example, the predetermined type and/or amount of tooth movement may have been pre-specified (i.e., prior to step A3) by a clinician and/or orthodontist (e.g., by way of user interface 400/2300) treating patient P1, and/or may have been determined in a prior performance of part of step A5 (and/or B1 to B5) (to be described below) for the present patient P1 during the patient P1's treatment plan (TP) or in another prior treatment plan (TP) for patient P1. In either case, the present step 4414 includes performing the foregoing comparison(s).

In a case where step 4414 results in a determination that there is a correlation (“Yes” in step 4414), then a record thereof is made (step 4416) for each record (R2 to Rn, SR2 to SRn) correlated to, and control passes to step 4418. In a case where step 4414 results in a determination that there is no correlation (“No” in step 4414), then control passes to step 4418.

In one example embodiment herein, the comparisons of at least steps 4410 and/or 4414 may be made on a tooth-by-tooth basis, or on a multiple tooth-by-multiple tooth basis, in the case of comparisons involving tooth types, on a jaw-by-jaw basis, in the case of jaw comparisons, and/or on an arch-by-arch basis, in the case of arch comparisons, and can involve feature mapping, although this example is not exclusive. In one non-limiting example embodiment herein, feature mapping can be performed in accordance with the technique(s) described in a publication by Phillip D. H. Wall and Jonas D. Fontenot, entitled “Application and comparison of machine learning models for predicting quality assurance outcomes in radiation therapy treatment planning”, Informatics in Medicine Unlocked 18 (2020) 100292, pp. 1-12. That publication is hereby incorporated by reference as if set forth fully herein. Also, in some example embodiments herein, steps 4410 and/or 4414 can be performed with respect to substantially all applicable patient P1's anatomy types and/or movements in the same step(s), before the corresponding next step is entered, or on a type-by-type or movement-by-movement basis, in which case the steps are cycled through multiple times, each for the specific type/movement under consideration until they are all evaluated relative to prior records.

Step 4418 will now be described. According to an example embodiment herein, step 4418 includes determining which of the record(s) R2 to Rn, SR2 to SRn, if any, correlated to in steps 4402, 4406, 4410, and/or 4414, sufficiently correlate in an overall manner to the record R1 of the present patient P1. By example, in one example embodiment herein this determination can be made by (a) determining whether the number of records made in steps 4404, 4408, 4412, and 4416 for respective ones of those records (R2 to Rn, Sr2 to SRn), exceeds a predetermined threshold, and (b) determining which of those records R2 to Rn, SR2 to SRn has the greatest number (if any) of correlations recorded in steps 4404, 4408, 4412, and 4416. If, for each of those records R2 to Rn, SR2 to SRn, the threshold is not equaled or exceeded (“No” in step 4418), then the records R2 to Rn, SR1 to SRn are deemed not sufficiently correlated in an overall manner to record R1, and control passes to step A4 which will be described below. On the other hand, if the number of records made in steps 4404, 4408, 4412, and 4416, with respect to any of the records R2 to Rn, SR2 to SRn, does equal or exceed the predetermined threshold (“Yes” in step 4418), then the record R2 to Rn, SR2 to SRn having the greatest number of records stored in steps 4404, 4408, 4412, 4416 is identified as having the best overall correlation to the record R1, and control passes to step 4420. For convenience, that record is identified herein as “best record (BR)”.

The value of the predetermined threshold employed in step 4418 can depend on the clinical criteria of interest. By example, in a case where the clinical criteria require a highest degree of correlation between compared records (R1) and (R2 to Rn, SR2 to SRn), then the predetermined threshold may be value “4”, whereas in a case where the clinical criteria require a relatively lowest degree of correlation between compared records (R1) and (R2 to Rn, SR2) to SRn, then the predetermined threshold may be value “1”.

Step 4420 will now be described. In one example embodiment herein, that step can include confirming or determining whether the treatment plan (TP) of the best record (BR) correlated to in step 4418 would provide a clinically acceptable result for the present patient P1. If it is determined that the treatment plan (TP) of the best record (BR) would provide a clinically acceptable result for the patient P1 (“Yes” in step 4420), then control passes to step A5 which will be described below. On the other hand, if it is determined that the treatment plan (TP) of the best record (BR) would not provide a clinically acceptable result for the patient P1 (“No” in step 4420), then control passes to step A4 which will be described below. The determination of whether or not a treatment plan (TP) provides a clinically acceptable result can be made in any number of ways, depending on the application of interest. For example, the best record (BR) itself may have been previously identified as being clinically acceptable (e.g., based on predetermined success/failure factors and treatment time), either by a clinician/orthodontist/patient satisfaction, by a previous performance of step 110′ or B4 (each to be described below), based on an indication stored in database A8, or the like.

It should be noted that steps 4402, 4406, 4410, 4418, 4420 are merely illustrative in nature, and are not intended to be limiting to the scope of the invention. In other example embodiments, other types of comparisons and determinations can be made in addition to, or in lieu of, those steps 4402, 4406, 4410, 4418, 4420. In some embodiments, a lesser (or greater) number of steps than shown in FIG. 44 can be performed, and/or the order of the steps can be different than as shown in FIG. 44. Also, in other example embodiments herein, other types of determinations can be made to determine the best record (BR), such as determining which jaw identified in patient records R2 to Rn, SR2 to SRn is most similar to the jaw of the present patient P1 identified in record R1. In that example embodiment, the most similar jaw is identified, and its associated record R2 to Rn, SR2 to SRn is selected as the best record (BR). Of course, in other example embodiments herein, other criteria can be employed in step 4418, and more than one record R2 to Rn can be identified as a best record (BR). In still another example embodiment herein, step 4420 need not be performed.

Referring now to FIG. 39 in conjunction with FIG. 44, a case where no overall correlation is determined to exist between record R1 and any records R2 to Rn, SR1 to SRn from the database A8 (“No” in step 4418) will now be described. In that case, control passes to step A4 of FIG. 39, where, in one example embodiment herein, step A4 is performed by performing steps B1 to B5 shown in FIG. 39. In one example embodiment herein, steps B1 to B5 are performed in the same manner as steps 104 to 112, respectively, of FIG. 1 described above. As such, for convenience those steps will not be further described herein. In one example embodiment herein, steps B1 to B5 are performed automatically without requiring operator input, although in other cases at least one or more of the steps can be performed, at least in part, manually by a clinician or orthodontist.

In accordance with an example aspect herein, all or at least part of steps B1 to B5 can be performed automatically in accordance with, or based at least partly upon, a latest optimized treatment plan (OTP) determined by a learning algorithm, such as algorithm 4304 described above, wherein in one example embodiment herein, the algorithm 4304 may have been trained to learn the optimized treatment plan (OTP) based on information (IB) from previous performances of steps B1 to B5 for prior patients P2 to Pn (and/or the present patient P1), although in other example embodiments herein, the algorithm 4304 may have been trained based on previous performances of step A5 for prior patients P2 to Pn (and/or patient P1), or a combination of both. In still other example embodiments herein, one or more of steps B1 to B5 can be performed automatically in accordance with, or based at least partly upon, a predetermined optimized treatment plan (OTP) (e.g., whether determined by a learning algorithm, such as algorithm 4304 described above, or not), associated with a predetermined “average” or reference dentition.

In a preferred embodiment herein, all, or at least some, data obtained or employed in steps B1 to B5, as well as information (e.g., treatment plan (TP) information) defining the steps themselves, is recorded in a database C1 as information (IB). In one example embodiment herein, the information (IB) includes one or more of the types of information (e.g., (I), (C), (S), (OR), (TP), (ITI), (OTR)) described above, relating to the present patient P1, and at least some of the information can be in-treatment information. Also, in one example embodiment herein, the treatment plan (TP) information includes steps or instructions (e.g., which may be computer-executable) for performing the steps B1 to B5. Data and information stored in the database C1 can be accessed by and provided to the database A8 for storage therein as part of corresponding record R1, in the case of patient P1 (or records R2 to Rn, in the case of other patients). Where the data/information is used training learning algorithm 4304 to generate an optimized treatment plan (OTP), at least some of the data/information can be included in a corresponding synthesized record SR1 to SRn.

After step B5, step A7 is performed. At step A7, information (e.g., z3, z4, z5 . . . zn) is obtained about the present treatment plan (TP) (i.e., from at least one of steps B1 to B5), and is recorded in the database A8 as part of the present record R1 for the present patient P1 and treatment plan (TP). In one example embodiment herein, the additional information recorded in the database A8 by step A7 includes at least post-treatment data, such as that relating to an outcome of the treatment plan (TP). The additional information can be in the form of, by example only, photographs of teeth and arches, and refinements made thereto, dental x-rays, digital and/or physical intra-oral impression data. In addition to or in lieu thereof, the additional information recorded in the database A8 by step A7 also can include obtained clinical detail information, such as information specifying whether there is adult or mixed dentition, periodontal disease, medical/dental history, and skeletal anomalies, refinements, and information defining such parameter(s). Additionally by example, the additional information obtained/recorded by step A7 also can include, without limitation, diagnostic stereolithography representations of any such dentition(s), dental x-ray data, and photographs, photographic arrays (e.g., an American Board of Orthodontic (ABO) photographs), notes, and the like.

The information recorded in database A8 by step A7, and/or information obtained by database A8 from database C1, can be used in training of the learning algorithm 4304 as described above to provide the optimized treatment plan (OTP).

In one example embodiment herein, teeth movements in steps B2 to B4 can be in accordance with movement vectors employed in corresponding ones of the steps B2 to B4, respectively, of at least one record R2 to Rn, SR2 to SRn stored in the database A8. According to an example embodiment herein, multiple iterations of steps B2, B3, and B4 (and, in some cases B1 and/or B5) can be used, in addition to one or more predetermined prior records R2 to Rn, to train the algorithm 4304 (e.g., in step 4500) to learn the optimum treatment plan (OTP) for those steps, and then that plan (OTP) is used to treat the patient P1 in a further iteration of steps B1 to B5 to provide an optimum treatment for the patient P1. As such, a feedback loop is provided to train the algorithm 4304 based on information (IB) from database C1 and/or information recorded in database A8 by step A7 in association with the performance of steps B1 to B5, to continuously improve the optimum treatment plan (OTP), even during patient P1's treatment. In one example embodiment herein, which records R2 to Rn, SR2 to SRn are used to train algorithm 4304 (e.g., in step 4500) can be based on correlations such as those described with respect to FIG. 44, or based on other predetermined criteria.

Referring again to FIG. 39, step A5 will now be described. Step A5 is entered in a case where the performance of step A3 (including sub-step 4418) results in a correlation to a best record (BR) (“yes” in step 4418) and where the performance of step A3′ results in a determination that the treatment plan (TP) of the best record (BR) provides a clinically acceptable result (“yes” in steps A3′ and 4420). In step A5 the best record (BR) is retrieved from the database A8 and employed to enable the method 3900 to perform (in step A5) pre-treatment and treatment procedures (i.e., a treatment plan (TP)) for the patient P1 under evaluation, based at least in part on the treatment plan (TP) of the best record (BR).

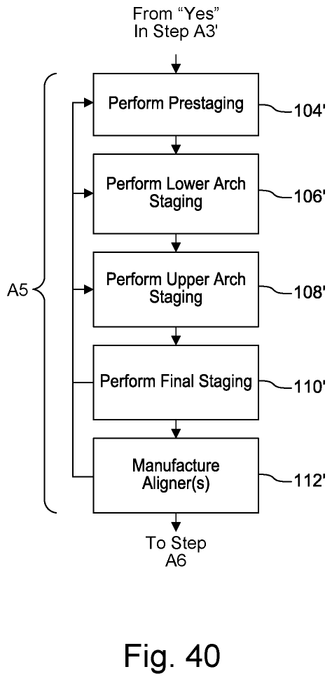

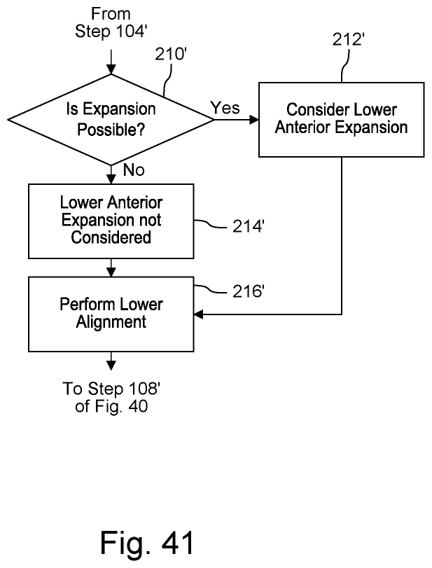

FIG. 40 shows in greater detail an example of how step A5 is performed, according to an example embodiment herein, and illustrates steps 104′, 106′, 108′, 110′, and 112′ representing step A5 in greater detail. In one example embodiment herein, steps 104′, 106′, 108′, 110′, 112′ are performed for the present patient P1, at least in part, in accordance with the treatment plan (TP) specified by the best record (BR), wherein the treatment plan (TP) of the best record includes steps 104′, 106′, 108′, 110′, 112′ (or steps 104, 106, 108, 110, 112) performed for other prior patients P2 to Pn (or previously for the present patient P1). More particularly, in one example embodiment herein, steps 104′, 106′, 108′, 110′, 112′ are performed in accordance with (e.g., in the same manner, in a substantially similar manner, or at least partly based on) steps 104′, 106′, 108′, 110′, 112′, respectively, of the treatment plan (TP) of the best record (BR) identified in step A3′. In one example embodiment herein, steps 104′, 106′, 108′, 110′, 112′ of FIG. 40 are performed automatically, although in other example embodiments herein, at least part of those steps may be performed manually. The steps 104′, 106′, 108′, 110′, 112′ of FIG. 40 according to the present example embodiment will now be described in greater detail.

Referring to step 104′ of FIG. 40, pre-staging is performed in that step, for the present patient P1. In one example embodiment herein, pre-staging 104′ includes evaluating/reviewing diagnostic records, such as, by example and without limitation, individual scans or a collage of scans, upper/lower arch STL files, 3D scans, 3D models (e.g., such as those described above), the patient's medical/dental history, the absence/presence of third molars or other teeth, the patient's general oral health and periodontal health, extra-oral photography and the like. Such information may be that obtained in step A1 for the patient P1, in one example embodiment herein. Pre-staging can be performed to determine which upper/lower tooth movements are possible or desired to be effected for the patient P1, in order to provide the patient P1 with an optimal tooth alignment in terms of function and/or aesthetics. As explained above, in one example embodiment herein, pre-staging 104′ is performed in accordance with (e.g., in the same manner, in a substantially similar manner, or at least partly based on) step 104′ of the treatment plan (TP) of the best record (BR) identified in step A3′. Also, according to an example aspect herein, an ideal arch form can determined and provided in step 104′ for patient P1, based on an arch form (i.e., a final or ideal arch form) of the best record (BR). The arch for the patient P1 may be the patient P1's arch form as it would be optimized in accordance with that of the best record (BR), or it can be the arch from of the best record (BR), depending on applicable operating criteria. In one example non-limiting embodiment herein, the providing of the ideal arch form can be employed in cases where, for example, step A3 involved a comparison that matched (e.g., in step 4410) a jaw of patient P1 to a jaw of a record R2 to Rn, SR2 to SRn of another patient P2 to Pn, although this example is not exclusive.

After step 104′, lower arch staging 106′ is performed. In one example embodiment herein, lower arch staging 106′ preferably is performed prior to upper arch staging 108′ (to be described below), and the lower arch staging 106′ involves treatment planning to define movement of at least one tooth of a lower arch, for purposes of overall teeth alignment. As described above, performing lower arch staging 106′ before upper arch staging 108′ helps to establish the lower arch/teeth first, thereby enabling a best fit to be achieved of the upper teeth to the lower teeth when steps 108′ and 110′ are later performed. Also in one example embodiment herein, lower arch staging 106′ is performed in accordance with (e.g., in the same manner, in a substantially similar manner, or at least partly based on) step 106′ of the treatment plan (TP) of the best record (BR) identified in step A3′.

FIG. 41 shows in greater detail an example of how lower arch pre-staging according to step 106′ is performed for the present patient P1, according to an example embodiment herein. In one example embodiment herein, FIG. 41 includes steps 210′, 212′, 214′, 216′, and those steps are performed in accordance with (e.g., in the same manner, in a substantially similar manner, or at least partly based on) corresponding steps 210′, 212′, 214′, 216′, respectively, of the treatment plan (TP) of the best record (BR).

In step 210′ of FIG. 41, a determination is made as to whether lower anterior/buccal expansion is possible. By example only, this determination can be based on an evaluation of the periodontal health (e.g., the presence of plaque, calculus, inflammation/recession or the like) of the patient's lower teeth/arch, and, in one example embodiment, is performed based on information evaluated/obtained in step 104′. If it is determined that the patient's lower teeth/arch are/is healthy (“Yes” in step 210′), then lower expansion or repositioning of the lower teeth can be considered (step 212′), and the procedure proceeds to step 216′, which will be described below. On the other, if it is determined that the patient's lower teeth/arch are/is not healthy (“No” in step 210′), then lower anterior expansion should not be considered, and other procedures can be considered such as, by example and without limitation, buccal expansion and/or sequential step distalization, or it can be decided to not treat the lower teeth/arch (step 214′).

Step 216′ is performed after either of steps 212′ and 214′ is performed. In step 216′, the 3D model and one or more of the lower teeth 500 (FIG. 5) can be manipulated to perform various procedures in an effort to plan to manipulate, and/or manipulate, the positions and orientations of one or more lower teeth 502 of the model, such that, after all steps 106′ to 108′ of FIG. 40 are performed, the upper and lower teeth will be optimally aligned (and placed in a prescribed final arrangement) with regard to function and aesthetics. Step 216′ in the context of the present example embodiment can include various considerations (e.g., based on information obtained in step 104′), functions and procedures. By example only and without limitation, step 216′ of the present embodiment can include one or more of moving (e.g., displacing) and/or rotating one or more lower teeth (e.g., starting with a molar, in one example), aligning one or more lower teeth, translation, distalization, expansion (where deemed appropriate, such as in a case of “Yes” in step 210′), proclination, lingualization, and/or mesialization of one or more lower teeth, and the like, in accordance with, or based at least partly upon, the corresponding lower arch staging of the best record (BR) correlated to in step 4418, to establish a symmetrical form and dental midline in the 3D model. Step 216′ also can include considering and/or performing tipping, torque (torqueing), intrusion, and/or extrusion to achieve those goals. The foregoing procedures, in on example embodiment herein, can be performed in accordance with (e.g., in the same manner, in a substantially similar manner, or at least partly based on) corresponding procedures of step 216′ of the treatment plan (TP) of the best record (BR).

Step 214′ and/or 216′ also can include considering factors such as the curve of Spee, and/or the curve of Wilson of the patient, in manipulating and/or determining how one or more teeth should be manipulated as described above (in step 216′). Also, step 216′ can include performing Class III anterior-posterior/sagittal corrections, which in one example can be addressed in the lower arch with sequential step distalization. Step 216′ also can include, in determining how one or more lower teeth should be manipulated as described above, determining a maximum displacement of the one or more teeth in the lower arch, determining an amount of force that should be applied to one or more teeth in order to move the teeth, determining an amount and/or angle of displacement and/or a travel path of one or more teeth, determining a length of time that the patient should wear an aligner to effect the movement, performing lower anterior expansion (in the case of “Yes” in step 210′), determining which teeth should be anchors and which ones to move, performing buccal expansion and/or sequential step distalization, or deciding not to treat (in the case of “No” in step 210′), and/or the like. In one example embodiment herein, step 216′ also is performed such that mesio-distal contact collisions are avoided or substantially minimized. Each of the foregoing procedures can be based, in one example embodiment, upon results obtained in pre-staging step 104′, and in accordance with (e.g., in the same manner, in a substantially similar manner, or at least partly based on) corresponding procedures the lower arch staging 106′ of the treatment plan (TP) of the best record (BR).

An assessment (e.g., an automatic assessment or by an orthodontist/technician) of result(s) of step 216′ can then be performed. According to an example aspect herein, steps 214′ and 216′ are performed without using or considering using attachments, interproximal reduction (IPR), buttons, elastics, metal braces, wires, and the like, and, in one example embodiment, the steps are performed to avoid or substantially minimize mesio-distal contact collisions.

After step 216′ of FIG. 41 is performed for the present patient P1, upper arch staging is performed in step 108′ (FIG. 40). Upper arch staging 108′ involves treatment planning to define movement of at least one tooth of an upper arch, for purposes of overall teeth alignment.

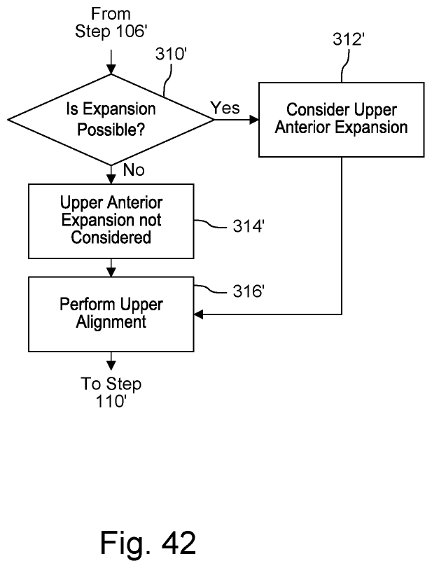

FIG. 42 shows in greater detail an example of how upper arch pre-staging of step 108′ is performed, according to one example embodiment herein. In one example embodiment herein, FIG. 42 includes steps 310′, 312′, 314′, 316′, and those steps are performed in accordance with (e.g., in the same manner, in a substantially similar manner, or at least partly based on) corresponding steps 310′, 312′, 314′, 316′, respectively, of the treatment plan (TP) of the best record (BR) identified in step A3′.

In step 310′ a determination is made as to whether upper anterior/buccal expansion is possible. By example only, this determination can be based on an evaluation of the periodontal health (e.g., the presence of plaque, calculus, inflammation/recession or the like) of the patient's upper teeth/arch, and, in one example embodiment, is performed based, at least in part, on information evaluated/obtained in step 104′. If it is determined that the patient's upper teeth/arch are/is healthy (“Yes” in step 310′), then upper expansion or repositioning of the upper teeth can be considered (step 312′), and the procedure proceeds to step 316′, which will be described below. On the other, if it is determined that the patient's upper teeth/arch are/is not healthy (“No” in step 310′), then upper anterior expansion should not be considered, and other procedures can be considered such as, by example and without limitation, sequential step distalization, or it can be decided not to treat the upper teeth (step 314′).

Step 316′ is performed after either of steps 312′ and 314′ is performed. In step 316′, the 3D model and one or more upper teeth can be manipulated to perform various procedures in an effort to plan to manipulate, and/or manipulate, the positions and orientations of one or more of the upper teeth of the model, such that, after steps 106′ to 108′ of FIG. 40 are performed, the upper and lower teeth will be optimally aligned (and placed in a prescribed final arrangement) with regard to function and aesthetics. Step 316′ in the present embodiment can include various considerations (e.g., based on information obtained in step 104′), functions, and procedures. By example only and without limitation, step 316′ can include one or more of moving (e.g., displacing) and/or rotating one or more upper teeth (e.g., starting with a molar, in one example), aligning one or more upper teeth, translation, distalization, expansion (where deemed appropriate, such as in a case of “Yes” in step 310′), proclination, lingualization, and/or mesialization of one or more upper teeth, and the like, to establish a symmetrical form and dental midline in the 3D model. Step 316′ also can include considering and/or performing tipping, torque (torqueing), intrusion, and/or extrusion to achieve those goals, in accordance with, or based at least partly upon, the corresponding upper arch staging of the best record (BR) correlated to in step A3. Also, step 316′ (and/or 314′) can include considering factors such as the curve of Spee, and/or the curve of Wilson of the patient, in manipulating and/or determining how one or more teeth should be manipulated as described above (in step 316′), and/or performing Class I/II anterior-posterior/sagittal corrections, which in one example can be addressed in the upper arch with buccal expansion and/or sequential step distalization. As described above, each of the foregoing procedures can be based, in one example embodiment, can be performed in accordance with (e.g., in the same manner, in a substantially similar manner, or at least partly based on) corresponding procedures of the upper arch staging 108′ of the treatment plan (TP) of the best record (BR).

Step 316′ also can include, in determining how one or more upper teeth should be manipulated as described above, determining a maximum displacement of the one or more teeth in the upper arch, determining an amount of force that should be applied to one or more teeth in order to move the teeth, determining an amount and/or angle of displacement and/or a travel path of one or more teeth, determining a length of time that the patient should wear an aligner to effect the movement, performing upper anterior expansion (in the case of “Yes” in step 310′), determining which teeth should be anchors and which ones to move, performing buccal expansion and/or sequential step distalization, or not treating the teeth (in the case of “No” in step 310′), and/or the like, for the upper arch. In one example embodiment herein, step 316′ also is performed in order to avoid (or substantially minimize) mesio-distal contact collisions. Also, in one example embodiment herein, step 316′ can include determining if anterior/posterior bite ramps would be useful to mitigate deep bites (anterior) or open bites (posterior), and such ramp(s) can be considered/employed in the model as deemed suitable. Each of the foregoing can be based, in one example embodiment, upon results obtained in pre-staging step 104′ (and/or lower staging step 106′). Also, again each of the foregoing procedures can be performed in accordance with (e.g., in the same manner, in a substantially similar manner, or at least partly based on) corresponding procedures of step 316′ of the treatment plan (TP) of the best record (BR).

An assessment (e.g., an automatic assessment or by an orthodontist/technician) of result(s) of step 316′ can be performed. According to an example aspect herein, the method of FIG. 42 is performed without using or considering using attachments, interproximal reduction (IPR), buttons, elastics, metal braces, wires, and, in one example embodiment, the method is performed to avoid or substantially minimize mesio-distal contact collisions.

After step 316′, the method of FIG. 40 is returned to and step 110′ is performed. Step 110′ includes performing final staging articulation/occlusion, and involves treatment planning to define articulation of the lower and upper arches, and can be performed in accordance with (e.g., in the same manner, in a substantially similar manner, or at least partly based on) corresponding step 110′ of the treatment plan (TP) of the best record (BR).

Step 110′ of FIG. 40 is performed to confirm that staging inter occlusal collisions are compatible with tooth movement and post staging occlusal collisions are both functional and stable, and to confirm that the upper and lower teeth are sufficiently aligned (and placed in a final, prescribed arrangement).

In one example embodiment herein, no IPR preferably is performed, and, in lieu of spacing in one arch and/or performing IPR in the other arch, a change in crown torque on the upper and lower anterior teeth can be performed, preferably to a level sufficient enough to close spaces in one arch and avoid IPR in the opposite arch. Oftentimes there is an anterior inclination (torque) problem, rather than a Bolton Discrepancy. Also in one example embodiment herein, step 110′ of FIG. 40 can include performing aesthetic/artistic positioning of the upper/lower anterior teeth via distal root/mesial crown angulation, in accordance with the corresponding final arch staging step 110′ of the best record (BR)'s treatment plan (TP).

In the foregoing manner, the position, orientation, and alignment of the teeth of the 3D model can be optimized in terms of function and aesthetics and the teeth can be placed in a prescribed final arrangement.

In step 112′ of FIG. 40, electronic models of one or more dental aligners can be generated, and then physical versions of the computer models are manufactured, wherein the aligners have structures that enable the patient's teeth to be incrementally repositioned and/or re-orientated in a manner as planned for/determined in steps 106′ to 110′ such that the patient's teeth can be optimally aligned in terms of function and aesthetics, and placed in the prescribed final arrangement. In one example embodiment, the dental aligners are transparent, and are formed of a polymer, plastic or other suitable material. In example embodiments herein, the dental aligners are formed by a manufacturing device (e.g., such as manufacturing device 408 of FIG. 4 to be described below) (e.g., 3D printer) which receives output signals from a computer processor (such as processor 402 described below) defining commands, and positions/orientations of upper and lower teeth, as determined in steps 106′ to 108′ (and/or as defined by the generated electronic models of the dental aligners), such that the manufacturing device forms corresponding aligners with geometries that, when each respective aligner is worn for a respective prescribed/predetermined amount of time by the patient, one or more respective teeth are repositioned/re-orientated over the time period in the manner defined by the aligner geometry and the corresponding signal(s) (and electronic models). By virtue of the patient wearing the aligners on his/her teeth, one or more teeth undergo a cumulative translation after being moved cumulatively by the incrementally-worn aligners. Each aligner (a representation of one of which is shown in FIG. 6) has a tooth receiving cavity 602 having a geometry 604 corresponding to an intermediate or final tooth arrangement intended for the aligner (and defined by the signal(s)). The patient's teeth are repositioned/re-orientated from their initial tooth arrangement to a final, prescribed tooth arrangement by virtue of the various incremental aligners being (removably) worn (at least intermittently) over a prescribed time period by the patient. After each incremental aligner is worn by the patient, and the patient's teeth are repositioned/re-orientated accordingly, then the next incremental aligner can be worn by the patient to achieve the next incremental repositioning/re-orientation.

Thus, as can be understood in view of the foregoing, in a non-limiting example embodiment herein, at least one or more of the incremental aligners has a construction such that, when worn by the patient, lower arch teeth alignment of the patient's teeth is performed in accordance with step 216′ of FIG. 41, at least one or more of the incremental aligners has a construction such that, when worn by the patient, upper arch teeth alignment of the patient's teeth is performed in accordance with step 316′ of FIG. 42, and at least one or more of the incremental aligners is constructed such that, when worn by the patient, final articulation of the patient's teeth is performed in accordance with step 110′ of FIG. 40. In some example embodiments herein, at least one or more of the incremental aligners has a construction such that, when worn by the patient, at least one of lower arch teeth alignment, upper arch teeth alignment, or final teeth alignment, of the patient's teeth, is performed by the aligner(s) in accordance with steps 216′, 316′, and 110′, respectively. Patient wear is performed until each of the aligners has been worn by the patient and the teeth are deemed to be placed in the final arrangement and to achieve optimal alignment. According to an example aspect herein, the process also is performed without requiring use of traditional metal braces, TADs, Class II connectors, headgear, elastics, wires and the like, as were required to reposition a patient's teeth in the prior art. Also according to an example embodiment herein, the process can be performed to overcorrect for an overbite, overjet, leveling curve of Spee/Wilson, rotations, proclinations of teeth, or the like. In other words, the geometry of the aligner(s) may be such that one or more teeth can be moved beyond a final tooth arrangement, to compensate for possible relapse and/or help speed up rate of correction, as determined during the stagings 106′ to 110′.

It should be noted that, as represented by lines in FIG. 40, at least part of one or more of the steps 104′ to 112′ can be performed over again in the process of aligning the teeth of the 3D model. By example only, it may be determined during performance of any of the steps 106′ to 112′ that at least part of one or more of the earlier-performed steps should be performed again to re-adjust the teeth according to the respective earlier step(s). Then the step(s) can be performed again to the extent deemed suitable, and the method continues as described above.

Also, in other example embodiments herein, step A5 and/or method 3900 can be performed multiple times for the present patient P1. As but one non-limiting example, each iteration may be performed for patient P1 independently for each of the pre-treatment stage, lower arch stage, upper arch stage, and final arch stage, respectively, of treatment.

Preferably the various types of stagings described above are performed to avoid or substantially minimize mesial/distal contact collisions, because movement of teeth with (plastic) aligners can require it, in at least some cases, given that tooth enamel cannot be forced/moved through tooth enamel (whether considering a singular tooth or plural teeth). Also, as described above, various types of considerations can be made, and various types of procedures and functions can be performed, in steps 216′ and 316′. By example and without limitation, one or more of steps 216′ and 316′ can involve individual/sequential distalization or step distalization, to enable correction of sagittal (anterior/posterior) malocclusions, without requiring use of elastics/headgear and other mechanisms typically required in the prior art, and while relieving crowding in lieu of collateral/unwanted protrusive movements of anterior teeth. Staging in steps 216′ and/or 316′ also can include automated (e.g., artificial intelligent) and/or manual movement of teeth to a prescribed curve of Spee and/or Wilson in a flexible grid with, by example and without limitation, 1 mm, 5 mm, or 10 mm increments. Bite Ramps (anterior/posterior) also can be employed (at least in step 316′) to mitigate deep bites (anterior) or open bites (posterior).

Also according to an example embodiment herein, staging according to step 110′ can include, by example and without limitation, an automatic or manual alignment of a best fit of final staging orthodontic occlusion to augment function/stability/retention of (e.g., clear) aligner treatment. Such staging also can include overcorrection of an overbite, overjet, leveling curve of Spee/Wilson, rotations, proclinations of teeth, or the like.

In one example embodiment herein, teeth movements in steps 216′, 316′, and/or 110′ can be in accordance with movement vectors employed in corresponding ones of the steps 216′, 316′, and/or 110′, respectively, of the best (BR). According to an example embodiment herein, multiple iterations of steps A3, A3′, A5, A6, A7 can be used to determine and record a best record (BR) for each iteration, and those best record(s) as well as data recorded in step A7 with respect to the iterations can be used to train the algorithm 4304 to learn an optimum treatment plan (OTP) for the patient P1, and then that plan (OTP) is used to treat the patient P1 in the method of FIG. 40 (where in this case, the record(s) associated with the optimized treatment plan (OTP) is deemed the best record(s) (BR(s))). As such, a feedback loop is provided to train the algorithm 4304 based on the best record (BR) and step A6/A7 of each iteration, to continuously improve the optimum treatment plan (OTP), even during patient P1's treatment. It should be noted that determining of the optimum treatment plan (OTP) is not limited to the foregoing examples, and the optimum treatment plan (OTP) can be determined in any manner as described herein, including, by example and without limitation, based on any of the training(s) of the algorithm 4304 described herein in association with step 4500 of FIG. 45, or in accordance with other predetermined operating criteria. Also, in some cases, the optimum treatment plan (OTP) may be based only on records R1 to Rn resulting from the performance of step A5 for the patients P1 to Pn, in other cases the optimum treatment plan (OTP) may be based only on records R1 to Rn resulting from the performance of steps B1 to B5 (described below) for the patients P1 to Pn, and in still other cases the optimum treatment plan (OTP) may be based on a combination of both, depending on which sources are used to train the algorithm(s) 4304 and applicable operating criteria.

Also according to one example embodiment herein, a template can be employed and included in the 3D space, wherein the template defies the prescribed arch/teeth arrangement. In this embodiment, the above method steps for aligning teeth in a scan (3D model) can be performed/effected by instructing the teeth (and/or arch) in the scan to become positioned in accordance with the arrangement of the template's arch/teeth. In one example embodiment, the instructing is performed by way of a user interface (e.g., user interface 406 and/or 2300). Also in one example embodiment, the instructing is performing by placing the scanned model over the template (or vice versa) in the 3D space, wherein, as a result, the teeth of the model take the arrangement of those of the template.

Having described step A5 in detail, step A6 will now be described. At step A6, all, or at least some, data (e.g., in-treatment data) obtained or employed in step A5 (including steps 104′ to 112′), as well as information (e.g., treatment plan (TP) information) defining the steps themselves, and in-treatment data, is obtained for the present patient P1, and, in one example embodiment herein, is stored in database A8 (in step A7) as part of a record R1 for the present patient P1 and treatment plan (TP) of the record R1.

In one example embodiment herein, information can be obtained in step A6 (and/or step A7) in accordance with known dental monitoring techniques, such as, e.g., Dental Monitoring by DentalMind, described at https://dental-monitoring.com Paris, France, although this example is not limiting. Such information, e.g., photographs or the like, can be used to train the learning algorithm 4304 as described above to provide the optimum treatment plan (OTP). By example only, pictures of tooth movements during treatments can be provided to train the learning algorithm 4304 so that a complete record of tooth movement, mid-treatment collisions, and in-treatment issues can be used to train the algorithm 4304 with useful data on whether a particular treatment was successful.

In one example embodiment herein, the information obtained in step A6 includes one or more of the types of information (e.g., (I), (C), (OR), (TP), (ITI), (OTR)) described above, relating to the present patient P1. Also, in one example embodiment herein, the treatment plan (TP) information includes steps or instructions (e.g., which may be computer-executable) for performing the step A5 (including steps 104′ to 112′). Collection of in-treatment data in step A6 allows treatment planning to be incrementally replanned and updated, as suitable, during the patient journey and treatment progress. In that way, treatment can be optimized dynamically during the course of treatment. By example, it is within the scope of the present invention to perform steps A3, A3′, A5, A6, and A7 multiple times for a same patient (e.g., patient P1), until the result (e.g., teeth alignment) is deemed sufficient. Of course, in at least some of such cases, aligners may be manufactured in step 112′ only after the result is deemed sufficient, versus for each iteration. Also, owing to step A6, the patient P1's treatment plan (TP) can be adjusted dynamically based on on-going feedback about the progress of the patient P1 through treatment. By example, collection of consistent in-treatment records at step A6, and feeding that data back (e.g., to train learning algorithm(s) 4304) for use in method 3900 enables the treatment to be adjusted during treatment, for each increment along the patient's treatment journey.

At step A7, additional information (e.g., z3, z4, z5 . . . zn) is obtained (from step A6) about the present treatment plan (TP) (i.e., step A5, including steps 110′ to 112′), and is recorded in the database A8 as part of the present record R1 for the present patient P1 and treatment plan (TP). In one example embodiment herein, the additional information recorded in the database A8 by step A7 includes at least post-treatment data, such as that relating to an outcome of the treatment plan (TP). The additional information can be in the form of, by example only, photographs of teeth and arches, and refinements made thereto, dental x-rays, digital and/or physical intra-oral impression data. In addition to or in lieu thereof, the additional information recorded in the database A8 by step A7 also can include obtained clinical detail information, such as information specifying whether there is adult or mixed dentition, periodontal disease, medical/dental history, and skeletal anomalies, refinements, and information defining such parameter(s). Additionally by example, the additional information obtained/recorded by step A7 also can include, without limitation, diagnostic stereolithography representations of any such dentition(s), dental x-ray data, and photographs, photographic arrays (e.g., an American Board of Orthodontic (ABO) photographs) and the like.

As pointed out above, data and information stored in the database A8 as a result of the performance of steps A6 and A7 can be accessed by and provided to the database A8 for storage therein as part of corresponding record R1, in the case of patient P1 (or records R2 to Rn, in the case of other patients). Where the data/information is used in learning algorithm 4304 to generate an optimized treatment plan (OTP), at least some of the data/information can be included in a corresponding synthesized record SR1 to SRn. Such data can be useful information (z2, z3), about the success and duration of treatment, and may include, by example and without limitation, photographs or the like of one or more teeth, refinements thereof, and the like. In one example embodiment herein, the pre-treatment, in-treatment, and post-treatment data are all synthesized to train learning algorithm 4304.

As described above, traditional treatment methodologies were haphazard and sequenced based on clinician preference. Traditional treatment methodologies were planned prior to treatment and only modified if the treatment was identified as problematic during a patient visit or if required by a clinical event such as a mid-course collision. Outcome data was not collected, nor was it available as a learning mechanism for future treatments.

According to an example aspect of the present application, on the other hand, treatment methodology can be performed through a deep learning algorithm that preferably is idealized based on prior outcomes. According to one example embodiment herein, first treatment phases are planned at the onset of treatment and future stages can be planned based upon a velocity of teeth through learnings based not only on prior outcomes, but also movement vectors obtained with pictures and/or other information from in-treatment data in the existing treatment. Also according to the present example embodiment herein, outcome data can be used for future treatments.

In accordance with the example aspects herein, the initial set-up and use of outcome data for future treatments, one or more algorithms herein search for similarity features between prior cases and at least one existing case. The features can include, by example only, at least one tooth and/or one or more jaws.

In an example case where a feature includes a tooth, feature mapping can be performed on a tooth-wise basis using a tooth-by-tooth comparison of a motion of a dentition from an initial starting condition to a final condition. Criteria for assessing tooth-by-tooth similarity can include, by example and without limitation, one or more of a tooth type, an age of a patient, and an amount and type of translation/rotation required to move the tooth to the new position, etc. (see, e.g., FIG. 44). A most effective series of steps to move similar teeth along a similar pathway is identified.

Additionally, as described above, feature mapping also can be performed on an entire jaw basis. In this embodiment, the most similar jaw of another patient (e.g., P2) is identified, and treatment is planned based on the general layout of the dentition.

Also in accordance with an example embodiment herein, a general treatment philosophy is followed. By, an ideal arch form can be generated (e.g., in a pre-staging step 104, 104′) based on a matching of an entire jaw (e.g., in step 4410) of patient P1 to the record R2, SR2 of a prior successful treatment plan (TP) for patient P2. The ideal arch form for a particular patient P1 can be based upon, by example, matching of an initial starting condition against the successful outcome and satisfaction of prior patients and clinicians. In one example embodiment herein, the ideal arch form can be fitted to the patient P1's arch form (e.g., model).

A next step can include aligning/rotating/buccally expanding the lower arch of patient P1 according to radiographic constraints and success on a tooth-wise (or other) basis matching prior successful tooth movements (e.g., of the treatment plan (TP) associated with record R2, SR2). If there is not enough room for dentition per the fitted idealized arch, the lower teeth can be stage distalized based on prior success of tooth distalization (indicated in the treatment plan (TP) of record R2 or SR2) on a tooth by tooth (or other) basis in the deep learning database (e.g., records therein). This step, in one example embodiment herein, can be performed according to step 106, 106′, B2 described above.

A next step can include using the lower arch as a template, and fitting the upper teeth to the lower teeth using an articulation model based on at least one prior successful finished treatment on an entire jaw in, e.g., 20 steps or less (and using, for example, a maximum of 0.3 mm and 3 degree movement(s) per step). This step, in one example embodiment herein, can be performed according to step 108, 108′, B3 described above.

Then, it can be confirmed that there are no mesial/distal tooth contact collisions during the staging of all tooth movements. (In one example embodiment this step can be performed in accordance with step 110, 110′, B4 described above, and can result in the patient P1 having substantially the ideal arch form). To achieve this, a model a magnetic force (e.g., provided by a magnetic device) on the mesial and distal side of each tooth can be employed in one example embodiment herein. The magnetic force, in one example embodiment herein, can model such that two adjacent teeth have the same polarity. Also, in one example embodiment herein, the modeled force can be altered to control the allowable contact between the two teeth. If no IPR is available or no IPR is required, a small force (<0.0009 mm) can be modeled to ensure no contact to the thousandth mm.

For the purposes of building a useful homegenized database, conventional treatment preferably is standardized. In one embodiment, a “starting” standardized treatment philosophy is available. In one embodiment, the initial treatment philosophy is as disclosed herein. Beginning with a standardized treatment philosophy minimizes the inter-treatment variability, facilitates a more consistent learning algorithm, and allows deep learnings from that philosophy to be consistently automated. The intelligent algorithm (e.g., 4304) optimizes a treatment plan for an individual patient based on the aforementioned match of a similar clinical case. The clinical case may be similar in certain respects to one case and in others to another case. The intelligent algorithm optimizes the outcome by setting the parameters of movement on an overall and individualized tooth basis and staging each tooth movement while preferably avoiding tooth-wise collision.

Again, example aspects herein can determine, provide and effect orthodontal treatment plan, based at least in part on prior successful treatments, and advantageously can adjust an existing treatment plan dynamically based upon on-going feedback about the progress of a patient (e.g., patient P1) through treatment. By example, collection of consistent in-treatment records at step A6, and feeding that data back (e.g., to train learning algorithm(s) 4304) for use in method 3900 enables the treatment to be adjusted during treatment, for each increment along the patient's treatment journey. It should be noted that the examples described above are not limiting, and that, in other example embodiments herein, the procedures described herein can be performed in a different order of steps or arrangement. By example only, in some embodiments herein steps 104′ and/or B1 need not be performed, or, alternatively, step 104′ and/or B1 can be performed as part of step A1 or another step, instead of being performed separately therefrom as described above.

Example aspects described herein improve the fields of dental and orthodontic methodologies and patient-home care treatment, as well as dental aligners and aligner fabrication, by virtue of providing the procedure(s) and device(s) described herein, and also by virtue of enabling virtual model and patient dental alignments to be performed/achieved in a more reliable, efficient, convenient, accurate, and high-quality manner relative to conventional methods and devices, while avoiding or substantially minimizing use of intrusive, uncomfortable, inconvenient, and oftentimes-inaccurate prior art mechanisms for aligning teeth as described above.

Intellectual Property-Clear aligner At Home/Studio “virtual orthodontics” model (one non-limiting example)

| | |
|---|---|
| | Articulation/Pretreatment Bite Registration: upper/lower occlusal collisions-AI/manual best fit of pre |
| | orthodontic treatment malocclusion, when no bite registration exists to articulate the patient's bite |
| | Pre-Staging: review diagnostic records (individual/collage photos, upper/lower stl/3D files/models, |
| | medical/dental history, absence/presence of third molars, general oral health and periodontal health) to |
| | determine what upper/lower tooth movements are possible for each patient |
| | Lower Arch Staging: begins with the lower arch, since we have less bone, the medullary bone is in a trough |
| | bordered buccal/lingually by cortical bone, resulting in limited tooth movement options. With clear aligners in |
| | an at home “virtual orthodontics” model, anterior-posterior/sagittal correction by anterior movement of the |
| | mandible is challenging without headgear, elastics, TAD's or Class II correctors, so we must be creative in our |
| | setups. |
| 1. | determine if lower anterior/buccal expansion is possible, generally determined by evaluating the |
| | periodontal health (plaque/calculus/inflammation/recession) of the lower teeth. |
| | a. if healthy, lower anterior expansion may be considered |
| | b. if not healthy, lower anterior expansion may not be considered, so consider buccal expansion and/or |
| | sequential step distalization or CNT |
| 2. | then rotate/align/distalize/tip/torque/intrude/extrude to establish symmetrical archform and dental midline |
| 3. | consideration may be given to the curve of spee and curve of wilson |
| 4. | Class III anterior-posterior/sagittal corrections are typically addressed in the lower arch with |
| | sequential step distalization |
| 5. | all movements must be assessed by the orthodontist/technician and accomplished without |
| | attachments/IPR/buttons/elastics/mesio-distal contact collisions. Candid's design software and |
| | manufacturing of aligners are unique in achieving Candid's Rx and successful outcomes. |
| | Upper Arch Staging: since the upper arch has more medullary bone, tooth movements are less limited, so |
| | the lower arch will now serve as a template for where we position the upper teeth. |
| 1. | determine if upper anterior/buccal expansion is possible, generally determined by evaluating the |
| | periodontal health (plaque/calculus/inflammation/recession) of the upper teeth. |
| | a. if healthy, upper expansion may be considered |
| | b. if not healthy, upper expansion may not be considered, so consider sequential step distalization or CNT |
| 2. | then rotate/align/distalize/tip/torque/intrude/extrude to establish symmetrical archform and dental midline |
| 3. | consideration may be given to the curve of spee and curve of wilson |
| 4. | Class I/II anterior-posterior/sagittal corrections are typically addressed in the upper arch with buccal |
| | expansion and/or sequential step distalization |
| 5. | determine if anterior/posterior bite ramps are needed to mitigate deep bites (anterior) or open bites |
| | (posterior) |
| 6. | all movements must be assessed by the orthodontist/technician and accomplished without |
| | attachments/IPR/buttons/elastics/mesio-distal contact collisions. Candid's design software and |
| | manufacturing of aligners are unique in achieving Candid's Rx and successful outcomes. |
| | Final Staging Articulation/Occlusion: confirm that staging inter occlusal collisions are compatible with tooth |
| | movement and post staging occlusal collisions are both functional and stable |
| 1. | No IPR-in lieu of spacing in one arch and/or IPR in the other arch, change the crown torque on the upper and |
| | lower anterior teeth, enough to close spaces in one arch and avoid IPR in the opposite arch. Often there is an |
| | anterior inclination (torque) problem, rather than a Bolton Discrepancy. |
| 2. | No IPR-aesthetic/artistic positioning of the upper/lower anterior teeth via distal root/mesial crown angulation |
| | *Staging: “Overlay upper/lower archforms/wires” to establish pre-defined archform and symmetry |
| | *Staging: establish lower arch/teeth first, then best fit the upper teeth to the lower teeth |
| | *Staging: “avoid mesial/distal contact collisions”-the only viable way to move teeth with plastic, since you can't |
| | move/force tooth enamel through tooth enamel. May be singular tooth/plural teeth |
| | *Staging: “individual/sequential distalization” or “Step distalization”-correction of sagittal (anterior/posterior) |
| | malocclusions without elastics/headgear, and relieve crowding in lieu of collateral/unwanted protrusive |
| | movements of anterior teeth. |
| | *Staging: AI/manual movement of teeth to prescribed curve of spee in flexible grid with 1 mm/5 mm/10 mm |
| | increments |
| | *Staging: AI/manual movement of teeth to prescribed curve of wilson in flexible grid with 1 mm/5 mm/10 mm |
| | increments |
| | *Staging: Bite Ramps (anterior/posterior) to mitigate deep bites (anterior) or open bites (posterior) |
| | *Staging: occlusal collisions-AI/manual best fit of final staging orthodontic occlusion to augment |
| | function/stability/retention of clear aligner treatment. Including, but not limited to overcorrection of |
| | overbite/overjet/leveling curve of spee/wilson/rotations/proclination of teeth, etc. |
| | *Staging: No IPR-in lieu of spacing in one arch and/or IPR in the other arch, change the crown torque on the |
| | upper and lower anterior teeth, enough to close spaces in one arch and avoid IPR in the opposite arch. Often |
| | there is an anterior inclination (torque) problem, rather than a Bolton Discrepancy. |
| | *Staging: No IPR-aesthetic/artistic positioning of the upper/lower anterior teeth via distal root/mesial crown |
| | angulation |

FIG. 4 is a diagram of an example data processing system 400. The system 400 of FIG. 4 includes a processor 402, a memory 403, a storage device 404, a communications device 405, a manufacturing device 408, a scanner 410, and user interfaces 406, all of which are coupled to a bus 401.

The processor 402 can communicate with the other components of the architecture through the bus 401. The storage device 404 includes one or more machine-readable media. The storage device 404 can be configured to read and write data including program instructions that may be executed by the processor 402 and operating systems (e.g., Microsoft Windows, UNIX) that allow the processor 402 to control the operation of the other components. In one example embodiment herein, storage device 404 can include database A8 and/or C1 and stores the content thereof. The communications device 405 can be configured to allow the processor 402 to communicate with, e.g., a network and the internet. The user interfaces 406 can include input devices (e.g., keyboards, mice, joysticks, trackpads, stylus tablets, microphones, and cameras, and the like) and output devices (e.g., displays, printers, speakers, and the like). The user interfaces 406 can comprise, at least in part, any of the interfaces or displays discussed herein. The user interfaces 406 can enable a user to, among other things, view and manipulate 3D models displayed in virtual space, as described herein, and can include, in one example embodiment herein, interface 2300.

The processor 402 may be configured to communicate with other components of the system 400, issue commands, receive scans from the scanner 410, and the like, and is configured to perform any of the procedures (at least in part) described herein and shown in the drawings. For example, the procedures may be stored on the storage device 404 in the form of machine-readable program instructions. The processor 402 also performs at least part of each of the methods shown and described herein, and executes algorithms (e.g., 4302, 4304, 4306) used herein. To execute a procedure, then, the processor loads the appropriate instructions, as stored on the storage device 404, into the memory 403, and then executes the loaded instructions to perform at least part of the procedures herein. During the course of the procedures (including, without limitation, steps 102-110 of FIG. 1, and/or any of the methods and procedures described herein), the processor 402 can generate commands, as well as initial, intermediate and final data/signals/information representative of determinations made during the procedure, and/or computer models (e.g., of dental aligners) generated during the procedure, and can provide any such data/signals/information/models to other components of the system 400, such as, without limitation, manufacturing device 408 and user interface(s) 406.

The manufacturing device 408 fabricates dental appliances such as dental aligners (e.g., FIG. 6) based on initial, intermediate and final data/signals/information and/or generated models received from processor 402, such as information/models determined/provided/generated by processor 402 during the performance of steps 102-110 (112), 102′-110′ (112′), B1-B4 (B5) described herein and defining specific aligner geometries that can effect prescribed tooth movements on a patient of interest. The manufacturing device 408 can include any suitable type of fabrication device for fabricating dental aligners, such as, by example and without limitation, 3D printers, CAD printers, etc. In an example embodiment herein, the manufacturing device 408 includes at least hardware components used to fabricate the dental aligners, and, in other embodiments, the manufacturing device 408 also can include additional components such as one or more other components such as those represented in FIG. 4 and/or components like those other components.

Scanner 410 can scan or otherwise acquire scans of casts of a patient's teeth/arch and/or a reproduction thereof (e.g., in step 102, 102′, A1, A7, B1, A6), and provides scan information/digital data to processor 402 for processing. The system 400 also can acquire scans from an external source by way of communications device 405, over a network of local connection.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine accessible or machine readable medium (memory) having instructions. The instructions on the machine accessible or machine-readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine readable medium,” or “memory” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments but should be defined only in accordance with the following claims and their equivalents.

In addition, it should be understood that the Figures are presented for example purposes only. The architecture of the example embodiments presented herein is sufficiently flexible and configurable, such that it may be utilized (and navigated) in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for orthodontic treatment planning, comprising:
providing a dental appliance having a geometry based on a lower arch stage of treatment planning defining movement of at least one tooth of a lower arch;
providing a dental appliance having a geometry based on an upper arch stage of treatment planning defining movement of at least one tooth of an upper arch; and
providing a dental appliance having a geometry based on a final arch stage of treatment planning defining articulation of the lower and upper arches,
wherein at least one of the lower arch stage of treatment planning, the upper arch stage of treatment planning, or the final arch stage of treatment planning is based at least in part on a predetermined prior treatment plan.

2. The method of claim 1, wherein the providings provide the dental appliances by controlling a manufacturing device to fabricate the dental appliances.

3. The method of claim 1, wherein the upper arch stage of treatment planning, the lower arch stage of treatment planning, and the final arch stage of treatment planning align teeth of the upper and lower arches.

4. The method of claim 1, wherein the upper and lower arches are included in a computer model.

5. The method of claim 1, wherein the geometries of the dental appliances differ from
one another, and the upper arch stage of treatment planning involves fitting teeth of the upper arch to teeth of the lower arch, while using the lower arch as a reference.

6. The method of claim 1, wherein the dental appliances are wearable by a patient, and wherein successive wears by the patient of respective ones of the dental appliances manipulate teeth of the patient to a final teeth arrangement.

7. The method of claim 1, wherein the predetermined prior treatment plan correlates to a patient for whom the method is performed.

8. The method of claim 7, wherein the predetermined prior treatment plan is for a different patient.

9. The method of claim 8, wherein the predetermined prior treatment plan correlates to the patient by virtue of at least one of a condition, demographic, or anatomy, of the patient correlating to at least one of a condition, demographic, or anatomy, of the different patient.

10. The method of claim 1, wherein at least one of the dental appliances is a computerized model dental appliance.

11. The method of claim 1, wherein the movements include one or more of displacing, rotating, aligning, a translation, distalization, expansion, proclination, lingualization, mesialization, tipping, torqueing, intrusion, and extrusion of at least one tooth, based on the predetermined prior treatment plan.

12. The method of claim 1, wherein the predetermined prior treatment plan is a machine learned treatment plan.

13. A system for positioning a patient's teeth, comprising a plurality of dental appliances having geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches, wherein at least one of the lower arch stage of treatment planning, the upper arch stage of treatment planning, or the final arch stage of treatment planning is based at least in part on a predetermined prior treatment plan, wherein the dental appliances are wearable on teeth of a patient, and wherein successive wears on the teeth of the patient of respective ones of the dental appliances manipulate the teeth of the patient to a final teeth arrangement.

14. The system of claim 13, wherein the predetermined prior treatment plan is for a different patient and correlates to the patient by virtue of at least one of a condition, demographic, or anatomy, of the patient correlating to at least one of a condition, demographic, or anatomy, of the different patient.

15. The system of claim 13, wherein the predetermined prior treatment plan is a machine learned treatment plan

16. A system for orthodontic treatment planning for a patient, comprising:
a processor; and
a storage medium storing computer-readable instructions that, when executed by the processor, cause the processor to perform a method comprising:
providing dental appliances having geometries defining a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches, wherein at least one of the lower arch stage of treatment planning, the upper arch stage of treatment planning, or the final arch stage of treatment planning is based at least in part on a predetermined prior treatment plan.

17. The system of claim 16, further comprising a user interface coupled to the processor and arranged to present a computer model of at least one of the lower arch or the upper arch to a user.

18. The system of claim 16, further comprising a manufacturing device coupled to the processor, wherein the processor provides the dental appliances by controlling the manufacturing device to cause the manufacturing device to fabricate physical dental appliances wearable by the patient.

19. The system of claim 16, wherein the dental appliances are wearable on teeth of the patient, and wherein successive wears on the teeth of the patient of respective ones of the dental appliances manipulate the teeth of the patient to a final teeth arrangement.

20. The system of claim 16, wherein the geometries of the dental appliances, when worn by the patient, cause movement of at least one tooth of a lower arch of the patient, movement of at least one tooth of an upper arch of the patient, and articulation of the lower and upper arches of the patient.

21. The system of claim 16, wherein the predetermined prior treatment plan is for different patient and correlates to the patient by virtue of at least one of a condition, demographic, or anatomy, of the patient correlating to at least one of a condition, demographic, or anatomy, of the different patient.

22. The system of claim 16, wherein the predetermined prior treatment plan is a machine learned treatment plan.

23. A system comprising a first dental appliance having a first geometry, a second dental appliance having a second geometry, and a third dental appliance having a third geometry, the system produced by a method comprising:
performing a lower arch stage of treatment planning to define movement, to be effected by the first geometry, of at least one tooth of a lower arch;
performing an upper arch stage of treatment planning to define movement, to be effected by the second geometry, of at least one tooth of an upper arch; and
performing a final arch stage of treatment planning to define articulation, to be effected by the third geometry, of the lower and upper arches,
wherein at least one of the lower arch stage of treatment planning, the upper arch stage of treatment planning, or the final arch stage of treatment planning is based at least in part on a predetermined prior treatment plan.

24. A computer-readable storage medium storing instructions which, when executed by a computer processor, cause the computer processor to perform a method for orthodontic treatment planning for a patient, the method comprising:
providing dental appliances having geometries determined based on a lower arch stage of treatment planning, an upper arch stage of treatment planning, and a final arch stage of treatment planning, the lower arch stage of treatment planning defining movement of at least one tooth of a lower arch, the upper arch stage of treatment planning defining movement of at least one tooth of an upper arch, and the final arch stage of treatment planning defining articulation of the lower and upper arches,
wherein at least one of the lower arch stage of treatment planning, the upper arch stage of treatment planning, or the final arch stage of treatment planning is based at least in part on a predetermined prior treatment plan.
